(19) United States
(12) Patent Application Publication
(10) Pub. No.: US 2023/0403604 A1
(43) Pub. Date: Dec. 14, 2023

(54) Network Node and Methods Therein

(71) Applicant: Telefonaktiebolaget LM Ericsson (PUBL), Stockholm (SE)

(72) Inventors: Sina Maleki, Malmö (SE); Niklas Andgart, Södra Sandby (SE); Ali Nader, Malmö (SE); Andres Reial, Höllvlken (SE); llmiawan Shubhi, Malmö (SE)

(21) Appl. No.: 18/034,829

(22) PCT Filed: Nov. 3, 2021
(86) PCT No.: PCT/EP2021/080479

§ 371 Date: May 1, 2023

Related U.S. Application Data
(60) Provisional application No. 63/109,117, filed on Nov. 3, 2020.
(60) Provisional application No. 63/110,729, filed on Nov. 6, 2020.

(51) Int. Cl. H04W 28/08; H04W 52/02; H04W 28/02

(52) U.S. Cl. CPC H04W 28/0917; H04W 28/0942; H04W 28/0967; H04W 52/0229; H04W 52/0241; H04W 28/0278

(57) ABSTRACT

A method performed by a network node that is configured to communicate with a WD is provided. The method comprises determining (202) a data radio bearer (DRB) status of the WD; determining (204) one or more bandwidth parts (BWPs) and/or one or more search space (SS) configurations of one or more BWPs for the WD based on the DRB status; when the DRB status is inactive, enabling (206) a power saving mode for the WD by configuring the WD with an SS configuration from the determined one or more SS configurations of the one or more BWPs for the WD based at least on the DRB status; and when the DRB status is active, disabling (208) the power saving mode or not enabling the power saving mode.

### TECHNICAL FIELD

The present disclosure relates to methods performed by a network node that is configured to communicate with a wireless device based on determining a data radio bearer (DRB) status of the wireless device. The present disclosure relates to wireless communications, and in particular, to at least one power saving configuration during DRB inactive.

### BACKGROUND

When no or little data is transmitted to a wireless device (WD), also referred to as a user equipment (UE), such that there is no or low data activity, the WD may continue performing its regular and potentially periodically scheduled operations. For example, the wireless device carries on physical downlink control channel (PDCCH) monitoring, channel state information (CSI) if periodic/semi-periodic CSI is scheduled, activates an inactivity timer (IAT) if a PDCCH and/or physical downlink shared channel (PDSCH) is transmitted (e.g., for a buffer state report (BSR) request), transmits sounding reference signal (SRS) if a periodic/semi-periodic SRS transmission is scheduled, and so on. These processes in turn lead to a large power consumption at the wireless device side, although the wireless device may not receive any user data.

For example, one of the power-consuming activities of the WD in an RRC CONNECTED mode is to monitor the PDCCH. In this activity, the WD needs to perform blind detection in its configured control resource sets (CORESETs), to identify whether there is a PDCCH sent to it, and act accordingly. On the other hand, data to the WD is not scheduled in most PDCCH monitoring occasions (MOs), and the WD thus wastes its energy.

### SUMMARY

In various embodiments, a network node and methods therein are provided to reduce power consumption in a WD. In particular, techniques are provided for reducing a power consumption in the WD based on a data radio bearer (DRB) status of the WD. In some embodiments, one or more bandwidth parts (BWPs) and/or one or more search space (SS) configurations are determined for the WD based on the DRB status of the WD. A number of unnecessary operations during DRB inactive can be reduced.

In some aspects, a method performed by a network node that is configured to communicate with a WD is provided. The method comprises determining a data radio bearer (DRB) status of the WD; determining one or more bandwidth parts (BWPs) and/or one or more search space (SS) configurations of one or more BWPs for the WD based on the DRB status; when the DRB status is inactive, enabling a power saving mode for the WD by configuring the WD with an SS configuration from the determined one or more SS configurations of the one or more BWPs for the WD based at least on the DRB status; and when the DRB status is active, disabling the power saving mode or not enabling the power saving mode.

In some aspects, a network node configured to communicate with a WD is provided, the network node being further configured to determine a DRB status of the WD; determine one or more BWPs and/or one or more SS configurations of one or more BWPs for the WD based on the DRB status; when the DRB status is inactive, enable a power saving mode for the WD by configuring the WD with an SS configuration from the determined one or more SS configurations of the one or more BWPs for the WD based at least on the DRB status; and when the DRB status is active, disable the power saving mode or not enabling the power saving mode.

Some embodiments advantageously provide methods, systems, and apparatuses for at least one power saving configuration during data radio bearer (DRB) inactive.

In one or more embodiments, a network/network node-based power saving adaptation is described with which the wireless device is reconfigured by the network/network node so that the wireless device has a possibility to operate in a more energy-efficient mode at least during DRB inactive. The indication of an opportunity for this mode or to enter this mode may be explicit or implicit.

The network/network node may adopt a criterion or criteria for indicating this mode or for reconfiguring the wireless device where the criteria, in one or more embodiments, is based at least on the ratio of DRB inactive duration to DRB active duration (denoted by DRB inactivity ratio or DRB inactive duration) being above one or more predefined thresholds, or being between two thresholds, or below one or more predefined thresholds.

Furthermore, the power saving mode, with which the network node helps the wireless device to achieve a lower power consumption based at least on the example criteria above, can include and/or correspond to one or more of the following non-exclusive examples:
Adapting control signaling transmission strategy to avoid triggering an inactivity timer (IAT) during NR DRB Inactive;
Reconfiguring Connected Mode-Discontinuous Reception (C-DRX) parameters;
Physical downlink control channel (PDCCH) monitoring occasion (MO)/search space (SS) reconfiguration and SS switching;
Wake-up signal (WUS) configuration;
Scell dormancy or activity status indication;
Multiple-input multiple-output (MIMO) layers reconfiguration;
Cross-slot scheduling reconfiguration; and
Bandwidth (BW) reconfiguration.

In embodiments, methods and mechanisms are disclosed with which the network node can determine thresholds or range(s) of thresholds for any of the above examples of power saving adaptation, and one or more of the thresholds can be adopted for wireless device power savings.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1A is schematic diagram illustrating a communication system in which embodiments of the present disclosure may be implemented;

FIG. 1B is a schematic diagram of an exemplary network architecture illustrating a communication system connected via an intermediate network to a host computer according to the principles in the present disclosure;

FIG. 2 is a flowchart illustrating a method performed by a network node in accordance with embodiments of the present disclosure;

FIGS. 3A and 3B are diagrams illustrating SS configuration switching based on DL buffer occupancy of a network node, using a zero threshold (FIG. 3A) and a non-zero threshold (FIG. 3B), in accordance with embodiments of the present disclosure;

FIG. 4 is a block diagram of a host computer communicating via a network node with a wireless device over an at least partially wireless connection according to some embodiments of the present disclosure;

FIG. 5 is a flowchart of an example process performed by a network node according to some embodiments of the present disclosure;

FIG. 6 is a flowchart of an example process performed by a wireless device according to some embodiments of the present disclosure;

FIG. 7 is a flowchart of another example process performed by a network node according to some embodiments of the present disclosure;

FIGS. 8A and 8B are schematic diagrams illustrating a network node in accordance with embodiments of the present disclosure;

FIG. 9 is a flowchart illustrating exemplary methods implemented in a communication system including a host computer, a network node and a wireless device for executing a client application at a wireless device according to some embodiments of the present disclosure;

FIG. 10 is a flowchart illustrating exemplary methods implemented in a communication system including a host computer, a network node and a wireless device for receiving user data at a wireless device according to some embodiments of the present disclosure;

FIG. 11 is a flowchart illustrating exemplary methods implemented in a communication system including a host computer, a network node and a wireless device for receiving user data from the wireless device at a host computer according to some embodiments of the present disclosure; and

FIG. 12 is a flowchart illustrating exemplary methods implemented in a communication system including a host computer, a network node and a wireless device for receiving user data at a host computer according to some embodiments of the present disclosure.

### DETAILED DESCRIPTION

As part of developing embodiments herein, the inventors identified a problem that first will be discussed.

User traffic data packets (e.g., wireless device traffic data packets) in New Radio (NR, also referred to as 5^{th} Generation (5G)) are transferred via a User Plane connection comprising one or more data radio bearers (DRBs). A DRB is a bearer carrying data over the air interface for data transmission between a UE and a network node. The establishment and maintenance of DRBs is handled by higher layers associated with wireless device and Radio Access Network (RAN). The Service Data Adaptation Protocol (SDAP) layer, which is the highest open systems interconnection (OSI) protocol layer of a RAN, maps incoming (e.g., from an application) user traffic data packets with a certain QoS demands to DRBs which are handled by the Packet Data Convergence Protocol (PDCP) layer. Multiple packets with same QoS classification can be mapped to the same DRB. The PDCP layer forwards these DRBs to Radio Link Control (RLC) layer entities which in turn map the received packets to the logical channels handled by Medium Access Control (MAC) layer.

After further processing, the MAC layer maps the received data to transport channels which are finally handled by the Physical layer of the 3GPP protocol stack. At the lowest layers of the 3GPP stack, the concept of DRBs is not visible. Within the higher layers of the network node (RAN), if there is data transmission over the DRB to/from the wireless device, the DRB status is considered as active, which may be referred to herein as “DRB active.” Otherwise, if there has not been any data activity, or there has been little, or low data activity, for a predetermined or predefined period of time (e.g., 5 seconds, 10 seconds, any one from a range of one second to 10 seconds, one of a range from 0.5 seconds to 10 minutes, implementation dependent and transparent to the wireless device) the DRB status is considered inactive (referred to as “DRB inactive”). In other words, for both “DRB active” and “DRB inactive,” the DRB may be setup and actively available for use (e.g., as described in existing wireless communication standards such as in 3GPP), but there may be a duration of time where there is no ongoing traffic (e.g., waiting for a server response, at the end of a connect, etc.) and/or little and/or low data activity, which is referred to as “DRB inactive” if this duration of time meets a predefined period of time.

As the wireless device physical/MAC layers may not be informed/aware of the RAN internal DRB status, these layers may carry on with the configured operations from the network/network node side, e.g., Physical Downlink Control Channel (PDCCH) monitoring, Channel State Information (CSI)-report, Sounding Reference Signal (SRS) transmission, Buffer Status Report (BSR), and so on.

In particular, during DRB inactive, no or little data is transmitted to the wireless device, i.e., the activity for data transmission is low or no such activities take place, but this network/network node status is transparent to the wireless device. As such, even though the wireless device is not expected to receive any data or receives little data, the wireless device may carry on with regular and potentially periodically scheduled operations. For example, the wireless device carries on physical downlink control channel (PDCCH) monitoring, channel state information (CSI) if periodic/semi-periodic CSI is scheduled, activates an inactivity timer (IAT) if a PDCCH and/or physical downlink shared channel (PDSCH) is transmitted (e.g., for buffer state report (BSR) request), transmits SRS if periodic/semi-periodic sounding reference signal (SRS) transmission is scheduled, and so on. These processes can lead to a large power consumption at the wireless device side, although the wireless device may not receive any user data.

For example, in E-UTRA-NR Dual Connectivity (EN-DC) operation, the new radio (NR, also referred to as 5^{th} Generation (5G)) leg (SCG) may be statically configured but when no data is present that can utilize it, the NR DRB is inactive. In practical EN-DC wireless devices, it has been observed that the total energy consumption is dominated by activity during the NR DRB inactive status, although no user plane data is transmitted on NR. Therefore, in existing systems, the wireless device may engage in unnecessary operation during DRB inactive.

Accordingly, considering that DRB inactive is a network/network node status which is transparent at the wireless device side, it is desirable for network/network node mechanisms to reduce the number of unnecessary wireless device operations during DRB inactive.

An object of embodiments herein is to reduce the overall power consumption of the WD and improve user experience.

The instant disclosure solves the problem with unnecessary wireless device operations during DRB inactive at least in part by enabling the wireless device to avoid unnecessary operations or reduce a number of the unnecessary operations during DRB inactive, thereby reducing the overall power consumption of the WD and improving user experience.

Some embodiments of the present disclosure provide a power consumption friendly configuration to a WD when it is operating in a state when no or little data is ongoing towards the WD.

For example, typical search space (SS) configurations implemented by a network node make a WD monitor PDCCH in every slot, while, most of the time, nothing is scheduled for the WD at that rate. Embodiments herein provide a way to reduce the number of unnecessary wireless device operations during DRB inactive. Some embodiments provide SS configuration change via a BWP switch (e.g., between two or more BWPs with different SS configurations implemented), or via SS-group changes, as discussed in more detail below.

Before describing in detail exemplary embodiments, it is noted that the embodiments reside primarily in combinations of apparatus components and processing steps related to at least one power saving configuration during data radio bearer (DRB) inactive. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

As used herein for one or more embodiments, for both “DRB active” and “DRB inactive,” the DRB may be setup and actively available for use (i.e., as described in existing wireless communication standards such as in 3GPP), but there may be a duration of time where there is no ongoing traffic (e.g., waiting for a server response, at the end of a connect, etc.), which is referred to herein as “DRB inactive” if this duration of time meets a predefined period of time. In one or more embodiments the predefined period of time may correspond to one of 5 seconds, 10 seconds, any one from a range of one second to 10 seconds and one of a range from 0.5 seconds to 10 minutes. In one or more embodiments, the predefined period of time may be based at least on a wireless device type and/or software application operating on the wireless device.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments provide at least one power saving configuration during data radio bearer (DRB) inactive.

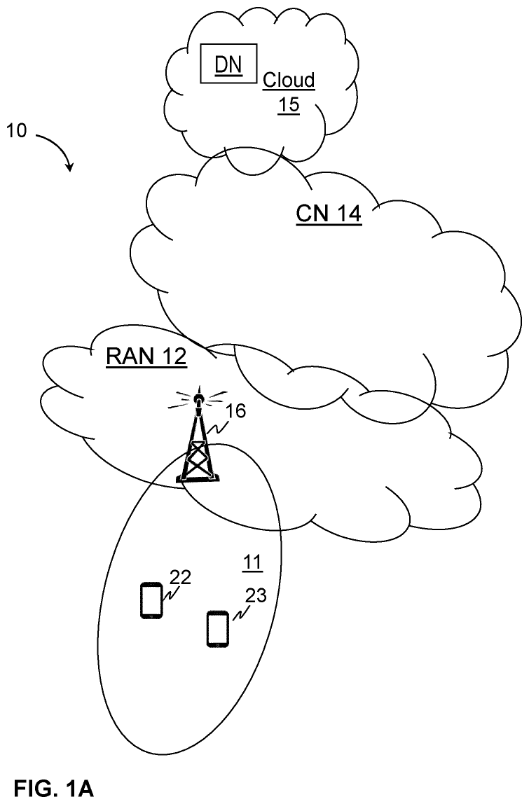

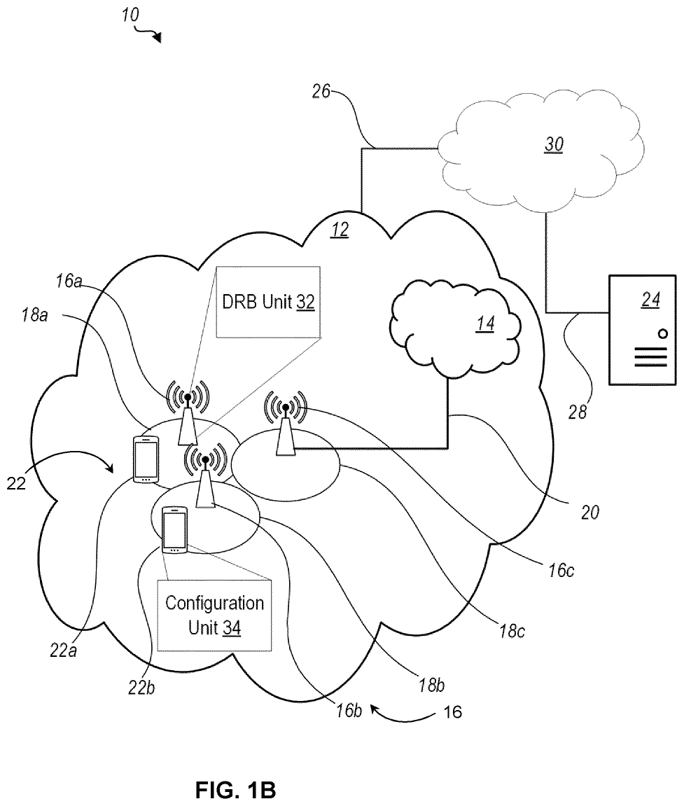

Referring now to the drawing figures, in which like elements are referred to by like reference numerals, FIG. 1A is a schematic overview depicting a communication system 10 wherein embodiments of the present disclosure may be implemented. The communication system 10, such as a wireless communications network, may be, e.g., a 3GPP-type cellular network that may support standards such as LTE and/or NR (5G). The communication system 10 comprises one or more RANs, such as a radio access network 12, and one or more CNs, such as a core network 14. The communication system 10 may use a number of different technologies, such as mmWave communication networks, Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the communication system 10 such as e.g., a network node 16. The network node 16 provides radio coverage in one or more cells which may also be referred to as a service area, a beam or a beam group of beams, such as e.g. a cell 11.

The network node 16 may be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, an NG-RAN node, a base transceiver station, a radio remote unit, an Access Point Base Station, a base station router, a transmission arrangement of a radio base station, a stand-alone access point or any other network unit capable of communicating with wireless devices, such as e.g. a wireless device (WD) 22 and a WD 23, within the service area served by that network node depending e.g. on the radio access technology and terminology used. The network node may communicate with WDs, or UEs, such as the WD 22 and the WD 23, in DL transmissions to the WDs and UL transmissions from the WDs.

In some embodiments, any of the WD 22 and the WD 23 may be in simultaneous communication and/or configured to separately communicate with more than one network node and more than one type of a network node. For example, the WD 22 and/or the WD 23 can have dual connectivity with a network node that supports LTE and the same or a different network node that supports NR. As an example, the WD 22 can be in communication with an eNB for LTE/E-UTRAN and a gNB for NR/NG-RAN. The WD 23 can also be in communication with an eNB for LTE/E-UTRAN and a gNB for NR/NG-RAN.

A number of WDs operate in the communication system 10, such as e.g. the WD 22 and the WD 23. Each of the WD 22 and the WD 23 may also be referred to as a device, an IoT device, a mobile station, a non-access point (non-AP) STA, a STA, a user equipment and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g., smart phone, laptop, mobile phone, sensor, relay, mobile tablets or even a small base station communicating within a cell. The WD 22 and the WD 23 may be served by the network node 16, e.g. when being located in the cell 11. In some implementations, the WD 22 and the WD 23 may be served by different network nodes.

Methods herein may be performed by the network node 16. As an alternative, a Distributed Node (DN) and functionality, e.g. comprised in a cloud 15 as shown in FIG. 1A, may be used for performing or partly performing the methods herein.

FIG. 1B a schematic diagram illustrating another embodiment of the communication system 10, according to embodiments of the present disclosure, such as a 3GPP-type cellular network that may support standards such as LTE and/or NR (5G), which comprises the access network 12, such as a radio access network, and the core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that, although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

As shown in FIG. 1B, the communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1B as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

In some embodiments, the network node 16 is configured to include a DRB unit 32 which is configured to perform one or more network node 16 functions as described herein such as with respect to at least one power saving configuration during data radio bearer (DRB) inactive. The wireless device (WD) 22 may be configured to include a configuration unit 34 which is configured to perform one or more wireless device 22 functions as described herein such as with respect to at least one power saving configuration during data radio bearer (DRB) inactive.

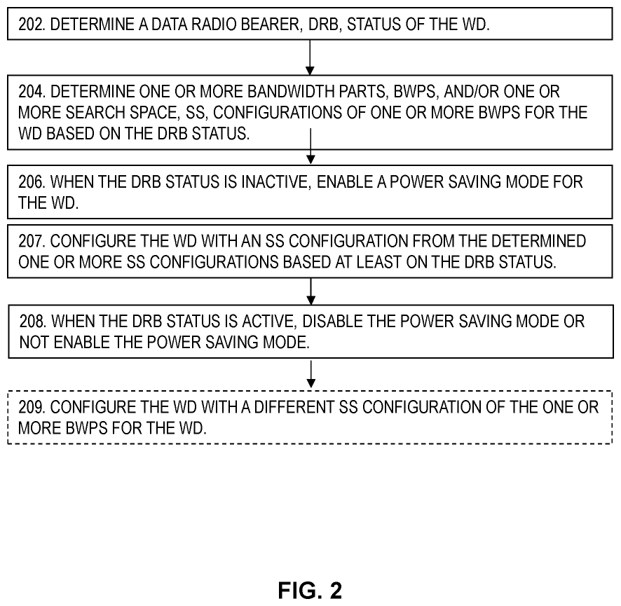

FIG. 2 shows example embodiments of a method performed by a network node 16 that is configured to communicate with the WD 22. The method comprises the following actions, which may be taken in any suitable order. Optional actions are referred to as dashed boxes in FIG. 2.

### Action 202

The network node 16 determines a DRB status of the WD 22.

The DRB status may be determined as active if there is data transmission over the DRB to/from the WD. The DRB status may be determined as inactive if there is no or little data transmission over the DRB to/from the WD. For example, the DRB status may be considered inactive if there has not been any data activity, or there has been little or low data activity, for a certain period of time, e.g., 20 ms, or 20 or 40 slots. The period of time may also be relative to a timer or as a portion of some timers, e.g., 20% time laps when an activity timer is running, e.g. a connected mode DRX inactivity timer (IAT) is running. For example, it the IAT timer is set to 100 ms, then the period of time for DRB status is set to 20 ms. Thus, the DRB status may be considered inactive after 20 ms.

In some embodiments herein, the DRB status may be determined based on various factors.

In some embodiments, the DRB status is determined at least in part based on a buffer occupancy of the WD 22. In such embodiments, the DRB status is inactive when the buffer occupancy of the WD 22 is zero or less than a threshold, and the DRB status is active when the buffer occupancy of the WD 22 is not zero or greater than the threshold. As used herein, the buffer occupancy indicates, for each logical channel, the amount of data that is currently queued for transmission (or retransmission) in Radio Link Layer (RLC) layer. The buffer occupancy may be a DL buffer occupancy in the network node. In some embodiments, the buffer occupancy is a UL buffer occupancy of the WD.

Non-limiting examples of the threshold may be a threshold on the amount of data in a buffer, or a ratio of amount of data in the buffer to the maximum possible amount of data, or an average amount of data delivered to the UE within a time period. The time period may be, e.g., 2 seconds, or another time period.

In some embodiments, the buffer occupancy of the WD 22 is a DL buffer occupancy of the WD 22 in the network node 16 and/or a UL buffer occupancy of the WD 22. The DL buffer occupancy in the network node 16 may be defined as a percentage of occupancy, i.e., amount of data, of the buffer in the network node 16 allocated for DL communications to the WD 22. The UL buffer occupancy of the WD 22 may be defined as a percentage of occupancy of a buffer in the WD 22 allocated for UL communications to the network node 16.

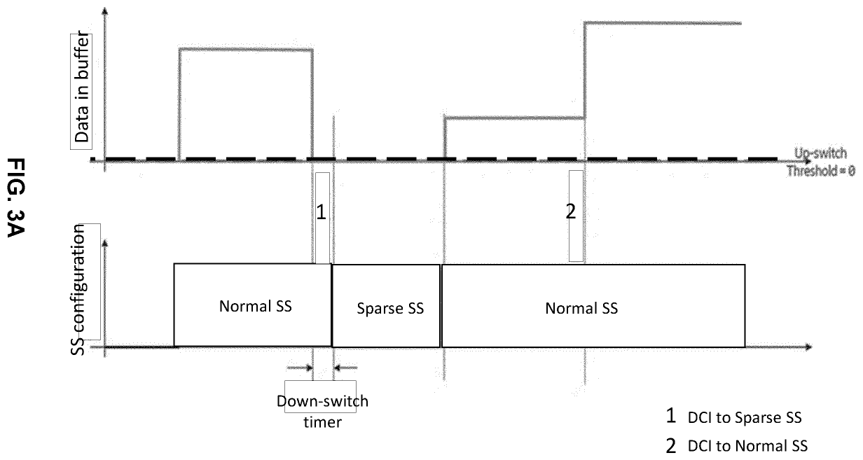

FIGS. 3A and 3B are diagrams illustrating an example of thresholds, referred to by way of example only as up-switch thresholds, and a time for when the WD is switched between the search spaces. FIG. 3A illustrates a switching that the WD is instructed to perform upon any activity (0 threshold), such that, if there is any data in a DL buffer of the network node, the SS configuration switches from normal configuration, such as, e.g., a dense SS configuration with SS periodicity of every slot (S11), to a sparse configuration such as, e.g. a configuration with SS periodicity of every 4^{th} slot (S14). As shown in FIG. 3A, the SS configuration switches from the normal SS configuration to the sparse SS configuration, e.g., via DCI to sparse SS, when the DL buffer has no data. The SS configuration switches back from the sparse SS configuration to the normal SS configuration, e.g., via DCI to normal SS, when the DL buffer has any amount of data that is greater than zero. FIG. 3A also illustrates a down-switch timer which may be used to determine whether there is no data in the DL buffer for a certain duration of time, such that a switch in the SS configuration does not occur immediately. The timer may be activated once it is detected that there is no data in the DL buffer, and, upon expiration of the timer, if there is still no data in the DL buffer, the SS configuration may be switched from normal to dense.

FIG. 3B illustrates an SS configuration switching that the WD is instructed to perform if the WD is more active than a certain threshold, e.g. after a certain number of bits in the DL buffer of the network node. A non-limiting example of such threshold is 3000 bits in the buffer in DL, though any other suitable threshold can be used. In FIG. 3B, the SS configuration switches from the normal SS configuration to the sparse SS configuration, e.g., via DCI to sparse SS, when the DL buffer has certain amount of data lower than the (non-zero) threshold. The SS configuration is switched back from the sparse SS configuration to the normal SS configuration, e.g., via DCI to normal SS, when the amount of data in the DL buffer becomes greater than the threshold. A down-switch timer may be activated once it is detected that the amount of data in the DL buffer becomes smaller than the threshold, and the SS switch may occur upon expiration of the timer. In some embodiments, the switching points are adapted to various WDs, e.g. URLLC devices may be treated differently compared to eMBB WDs. Also, in some embodiments, there may be hysteresis and a timer used for the thresholds to lower an excessive ping pong configuration change between two search spaces.

In some embodiments, determining the DRB status further comprises determining a second threshold. When the buffer occupancy of the WD 22 is greater than the second threshold, the DRB status is active. Non-limiting examples of the second threshold may be 2000 bits.

In some embodiments, the DRB status is determined at least in part based on a DRB inactivity ratio of the WD 22. In such embodiments, the DRB status is inactive when the DRB inactivity ratio of the WD 22 is above a third threshold, and the DRB status is active when the DRB inactivity ratio of the WD 22 is below the third threshold. Non-limiting examples of the third threshold may be 0.5 (i.e. 50%). In some embodiments, the DRB inactivity ratio of the WD 22 is defined as a ratio of DRB inactive time to DRB active time. In some embodiments, the DRB inactivity ratio of the WD 22 may be defined as a fraction of the DRB inactive time out of the total time.

In some embodiments, any one or more out of the threshold, the second threshold, and the third threshold are determined based on a WD type, a WD traffic type, and/or a service requirement. For example, for a WD type with Reduced Capability (RedCap), power saving may be more important than for Mobile Broadband (MBB) devices, e.g. smartphone. The service requirement may be, e.g., an ultra-reliable low latency communications (URLLC) requirement, and thus the thresholds for inactivity may be set higher since data as small as it is needs to be delivered fast. Any other thresholds described herein may be determined based on one or more out of the WD type, the WD traffic type, and/or the service requirement.

In some embodiments, a current SS configuration of a WD is changed via a BWP switch between two or more BWPs with different SS configurations. For example, in some embodiments, the wireless device 22 may have been configured with different SS configurations in different BWPs. For example, the wireless device 22 may be configured with a sparser SS in one BWP (e.g., a SS periodicity of every 2 slots or more), and a denser SS in another BWP (e.g., SS periodicity of every 1 slot). The network node 16 may set the SS periodicity of the sparser SS based at least on the periodicity of a periodic measurement (e.g., periodic CSI-RS). For example, the network node 16 may (re)configure the wireless device 22 (e.g., via higher layer signaling such as RRC reconfiguration) with a higher SS periodicity (e.g., SS periodicity of 2 slots or more with respect to SS periodicity of 1), or a lower SS duration (e.g., a duration of 1 with respect to two or more), if DRB inactivity ratio or DRB inactive duration goes above a threshold, also referred to herein as a third threshold. As another example, if the DRB inactivity ratio or DRB inactive duration goes above a threshold, the network node 16 instructs the wireless device 22 move to a first pre-configured SS configuration, and, if the DRB inactivity ratio or DRB inactive duration goes below the threshold, the network node 16 instructs the wireless device 22 move to a second pre-configured SS configuration. For example, the wireless device 22 may be instructed to change the active (current) BWP to one with a sparser SS configuration, or to a PDCCH configuration group with a sparser SS for a low DRB inactivity ratio.

As a further example, in some embodiments, if the current DRB inactive duration goes above a threshold (i.e., an example of a criterion), e.g., the third threshold, while the wireless device 22 is in active time, e.g., during an on-going IAT, the network node 16 may instruct the wireless device 22 leave the active time through a go-to-sleep signal (GTS), e.g., via a MAC-CE command.

Since the network node 16 expects that it is unlikely that the wireless device 22 is soon going to be scheduled (i.e., an example of a criterion), in one or more embodiments, the network node 16 configures the PDCCH search space such that the number of blind decodes for the wireless device 22 is decreased.

In some embodiments, the WD may be indicated with L1-based GTS function using SS configuration changes. In one example, if the WD is configured with search-space (SS) group switching, the WD can be configured with a sparse SS (WUS-like, e.g., one PDCCH MO per DRX on-duration and no MO during the rest of the on-duration or IAT extension) in the SS group0 and dense search spaces (e.g., every slot) in the SS group1. In SS group switching, the WD may also be configured with explicit triggering through DCI (e.g., non-scheduling DCI 2-0, etc.) to switch between SS groups and implicit switching (e.g., through an expiration of switching timer) to switch back from SS group1 to SS group0 To perform GTS at the end of a traffic burst, the network node may transmit a switch command (e.g., via DCI 2-0) so that the WD switches from monitoring PDCCH according to SS group1 to monitoring PDCCH according to SS group0 The WD may return to monitor according to SS group0 without waiting for timer expiry, and may enter deep sleep.

In some embodiments, WUS SS (for detecting DCI 2-6) is included in SS group 0 and implicit SS switching is configured. Upon receiving a WUS, the WD both starts monitoring the on-duration and also transitions to gr1 for immediate dense monitoring pattern. In some embodiments, the SS group selection state is kept across DRX cycles, so only when WUS is detected, the WD switches to dense monitoring SS. These two approaches may also be applied when a virtual WUS function is implemented via special SS designs for scheduling DCIS.

### Action 204

The network node 16 determines one or more bandwidth parts (BWPs), and/or one or more search space (SS) configurations of one or more BWPs for the WD 22 based on the DRB status.

In some embodiments, one or more BWPs and/or the one or more SS configurations relate to a WD type, a WD traffic type, and/or a service requirement. The service requirement may be, e.g., a ultra-reliable low latency communications (URLLC) requirement.

In some embodiments, a BWP is switched based on the DRB status of the WD, which may be done in downlink (DL) or uplink (UL). For example, an active BWP in a serving cell can be switched based on a BWP indicator field in DCI. For example, for paired spectrum such as Frequency Division Duplexing (FDD), DL DCI can only indicate the switch of DL BWP, and UL DCI can only indicate the switch of UL BWP. As another example, for unpaired spectrum such as Time Division Duplexing (TDD), both DL and UL DCI can be used to indicate the switch of DL and UL BWP. In some embodiments, the WD may receive a DCI indicating active DL (UL) BWP change in a certain number of OFDM symbols of a slot, e.g., in the first 3 OFDM symbols of a slot.

In some embodiments, BWP can be activated or de-activated by a timer, physical layer DCI signaling, or higher layer RRC signaling.

In some embodiments, determining the one or more SS configurations is performed using one or more criteria that comprise one or more out of:
a DL buffer occupancy of the WD 22 in the network node 16;
a total DL buffer occupancy in the network node 16 of WDs which the network node 16 is serving;
a UL buffer occupancy of the WD 22;
a buffer occupancy in the network node 16 of another WD, e.g., the WD 23, in a communication system comprising the network node 16 and the WD 22;
an energy consumption of the WD 22;
DL and/or UL radio resource consumption;
scheduling delays; and
at least one time division duplex (TDD), configuration and/or at least one TDD pattern used in a DL and/or a UL in the one or more BWPs.

In some embodiments, change in an SS configuration, for SS adaptation, may be performed via a DL BWP switch. For TDD, either DL DCI or UL DCI can indicate DL BWP change, and UL BWP is changed accordingly. In some cases, if a BWP switch is triggered by DL, the network node may send to the WD a DL DCI for DL/UL BWP change. Then an internal indication may need to be sent to UL UPC regarding UL BWP change. In some cases, if a BWP switch is triggered by UL, a UL DCI may be sent out for DL/UL BWP change. Then an internal indication may need to be sent to DL UPC regarding DL BWP change.

### Action 206

When the DRB status is inactive, the network node 16 enables a power saving mode for the WD 22. In the power saving mode, the WD 22 uses the one or more BWPs, and/or the one or more SS configurations of one or more BWPs determined for the WD 22, wherein the one or more BWPs and the one or more SS configurations are appropriate for the power saving mode. This means that a first BWP may be configured with normal SS, e.g., SS periodicity of every 1 slot, and a second BWP (so called power saving BWP) may be configured with an SS periodicity of e.g., every 4 slots, and then the UE receives an indication e.g., a DCI, to switch from the first BWP to the second BWP, and as such the UE can monitor PDCCH less, and thus saves power.

A BWP can be defined as a subset or a part of total carrier bandwidth. The BWP comprises a number of contiguous physical resource blocks (PRBs) or Common Resource Blocks (CRBs) configured inside a channel bandwidth, for a given numerology. In general, devices of different bandwidth capabilities may be configured with different BWPs. For example, a network node, such as a base station, may support a very wide channel bandwidth which may not be supported by some UEs. BWP provides a mechanism to flexibly assign radio resources, such that the signals for a UE are confined in a portion of network node channel bandwidth that the UE can support. In some embodiments, for each serving cell of a UE, the network configures at least one downlink (DL) BWP (i.e., the initial DL BWP). The network may configure the UE with up to four DL BWPs, but only one DL BWP can be active at a given time. If the serving cell is configured with an uplink (UL), the network configures at least one UL BWP. Similar to the DL, in some embodiments, the network may configure the UE with up to four UL BWPs, but only one UL BWP can be active at a given time.

From a UE's perspective, all physical channels and most physical signals are configured per BWP by the network. Thus, switching among multiple BWPs for the UE usually occurs with UE configuration change. Each BWP has specific physical characteristics including frequency location, bandwidth, SCS, and cyclic prefix. UE configuration needs to, at least, convey the physical characteristics of the associated BWP. The network node may thus apply a BWP switching to reconfigure a UE such that the UE configuration changes.

### Action 207

When the DRB status is inactive, the network node 16 enables the power saving mode for the WD 22 by configuring the WD 22 with an SS configuration from the determined one or more SS configurations of the one or more BWPs for the WD 22 based at least on the DRB status.

In some embodiments, the configuring the WD 22 with the SS configuration comprises:
determining a physical downlink control channel (PDCCH) monitoring occasion MO configuration associated the SS configuration; and/or
determining at least one BWP having the SS configuration.

In some embodiments, the network node 16 causes the WD 22 to change an SS configuration via a BWP switch, e.g., between two or more BWPs with different SS configurations. In some embodiments, the network node 16 causes the WD 22 to change an SS configuration via SS-group changes. For example, the network node 16 may consider setting the SS periodicity of the sparser SS based at least on the periodicity of the periodic measurement (e.g., periodic CSI-RS). In some embodiments, as an example, two BWPs are configured, each with a different minimum SS periodicity, e.g., BWP1 with SS periodicity of every 4^{th} or 5^{th} slot (sparse SS) and BWP2 with SS periodicity of 1 slot (dense/normal SS). Whenever there is no or little data to be delivered to the WD, e.g., DRB is indicative of low or no activity, then the WD is indicated to move to BWP1 and monitor PDCCH at a less than normal rate. When data comes in, i.e., DRB is indicative of a higher activity, then the network node indicates the WD to move to BWP2 and monitor PDCCH more frequently. In some embodiments, an SS switching/PDCCH skipping mechanism may be used where the WD is instructed to move between different SS groups with different periodicities or it may be instructed to skip PDCCH for a certain duration.

In some embodiments, the wireless device 22 may be configured with one or more PDCCH candidate monitoring occasions (Mos or MOs) associated with one or more SS configurations. In some embodiments, the wireless device 22 may be configured with two or more PDCCH monitoring configuration groups. For example, one group can have a lower frequency of PDCCH MOs (sparser monitoring) and/or shorter duration than the other one. In such a case, the wireless device 22 may be indicated by the network node 16 to move to a different PDCCH monitoring configuration group. The network node 16 may set the SS periodicity of the sparser SS based at least on the periodicity of a periodic measurement (e.g., periodic CSI-RS).

In some embodiments, the PDCCH MO of the SS configuration used when the DRB status is inactive is sparser than a PDCCH MO of an SS configuration used when the DRB status is active, and the network node 16 configures the WD 22 with an offset value such that the PDCCH MO used when DRB status is inactive is non-overlapping with the PDCCH MO used by another WD, e.g., the WD 23, served by the same network node. In some embodiments, the offset value comprises an offset in frequency and/or time. For example, the offset may be 1 or 2 slots, or greater than 2 slots. In some embodiments, the WD 22 and the another WD (e.g., the WD 23) have an inactive DRB status.

Thus, in some embodiments, the network node may also configure the WD 22 with the offset value of the sparser SS-group so that the PDCCH MO does not overlap with PDCCH MO of, in particular, the sparser SS-group of other WDs in time and/or frequency. The network node, therefore, may configure the sparser SS-group of the WDs to have the same PDCCH MO in the time domain when the network node is still able to set the PDCCH MO of the sparser SS-group of those WDs to be in the different frequency location.

In some embodiments, in the power saving mode, the WD has a power saving configuration, which can further include one or more out of: a control signaling transmission configuration to avoid triggering IAT; a reconfiguring connected mode-Discontinuous Reception (C-DRX) parameters; a wake-up signal (WUS) configuration; a secondary cell (Scell) dormancy or activity status indication; a multiple-input multiple-output (MIMO) layers reconfiguration; a cross-slot scheduling reconfiguration; a bandwidth (BW) reconfiguration; and a channel state information (CSI) reporting rate reconfiguration.

### Action 208

When the DRB status is active, the network node 16 disables the power saving mode or not enables the power saving mode.

In some embodiments, the network node 16 disables the power saving mode or not enables the power saving mode by configuring the WD 22 with a different SS configuration of the one or more BWPs for the WD 22.

### Action 209

In some embodiments, the network node 16 disables the power saving mode or not enables the power saving mode by configuring the WD 22 with a different SS configuration of the one or more BWPs for the WD 22.

In some embodiments, the network node 16 disabling or not enabling the power saving mode further comprises the network node 16 configuring a timer for the WD 22 when the WD 22 is configured with an SS configuration used for an active DRB status. In some embodiments, when the timer expires, the WD 22 automatically switches to an SS configuration for an inactive DRB status. In some embodiments, the timer is activated by the network node 16 through a downlink control information, DCI.

In some embodiments, the timer comprises an inactivity timer that is used to determine when to switch from a dense or denser SS configuration back to a sparse or sparser (or less dense) SS configuration for an inactive DRB status. In some embodiments, a bwp-InactivityTimer in 3GPP may be used to instruct the UE switch back to the sparse SS, which may be done without sending a DCI. This may advantageously allow reducing PDCCH load.

In embodiments in which bwp-Inactivity Timer is used, a sparse SS BWP may be set as default BWP, and bwp-InactivityTimer and defaultDownlinkBWP-Id may be set to the UE such as the WD 22 in RRC reconfiguration.

Furthermore, in some embodiments, when the WD 22 is in a first state where it is configured to monitor group0, then, when the UE detects a DCI message having format 2-0 (referred to as DCI format 2-0, or more simply DCI 2-0) and a switching field searchSpaceSwitchTrigger is configured in the WD, the WD transitions to a second state where it starts a timer, monitors group1 and stops monitoring group0. When the WD is in the second state, if it detects DCI 2-0 and the switching field is 0, or when the timer expires, the WD transitions back to the first state, starts monitoring group0 again, and stops monitoring group1.

Accordingly, in some embodiments, the WD can be switched between the two search space groups through detection of DCI format 2-0. This is done, for example, by configuring the WD with the RRC parameter searchSpaceSwitchTrigger-r16 which provides a location for the search space switching field (for a serving cell) in the DCI format 2-0. The search-space-set-switching field is one bit in size, where a bit value of zero indicates one group and a value of one indicates the second group. These two groups are referred to herein as group0 and group1, where the search-space-set-switching field takes the values zero and one, respectively. However, it will be appreciated that these names are arbitrary.

In some embodiments, the procedure for explicit switching using DCI format 2-0 is as follows. If the WD is not monitoring PDCCH on search space sets corresponding to group0 and the WD detects DCI format 2-0, then the UE switches to search space sets of group0 provided the search-space-set-switching field indicates a value of zero, and stops monitoring PDCCH on search space sets associated with group1.

If the WD is not monitoring PDCCH on search space sets corresponding to group1 and the WD detects DCI format 2-0, then the WD switches to search space sets of group1 provided the search-space-set-switching field indicates a value of one. The WD also stops monitoring PDCCH on search space sets corresponding to group0 and starts a timer with a duration provided by the searchSpaceSwitchingTimer.

If the WD is monitoring PDCCH on search space sets corresponding to group 1, then the WD switches (or starts monitoring on) to search space sets of group0 and stops monitoring on group1 at either expiration of the searchSpaceSwitchingTimer or at the last slot of a remaining channel occupancy duration for the serving cell that is indicated by DCI format 2-0.

In some embodiments, SS switching between two or more search spaces may be performed as described in PCT/EP2021/053545.

In some embodiments, the DRB status is further determined based on a buffer status of another WD in the system, such that the DRB status is inactive when a total buffer occupancy of the WDs (e.g., the WD 22 and the WD 23, in some embodiments) is zero or less than a fourth threshold, and the DRB status is active when the total buffer occupancy of the WDs is not zero or greater than the fourth threshold.

In one or more embodiments, the wireless device 22 is configured with a large aggregation level (AL), larger than would otherwise be necessary or needed by the wireless device 22 given one or more existing wireless device 22 parameters and/or operation. Since the scheduling of the wireless device 22 is unlikely, the larger system resources associated with the higher aggregation level may, in practice, not be used, but the larger AL may make it easier to decode PDCCH with fewer antennas, or a more power efficient radio configuration. The configuration of a large AL to a wireless device 22 which has previously reported a good CSI (i.e., CSI meet a predefined CSI criterion) may also serve as an indication that the wireless device 22 can relax its receiver settings.

In some embodiments, the network node 16 uses one or more thresholds for power saving adaptation mechanisms based on a WD type, WD traffic type and/or service requirements. In such embodiments, if the WD type, WD traffic and/or service requirement require low latency traffic (e.g., lower latency than latency required for other WD types/services) or have jitter requirements of a certain stringency (e.g., more stringent than for other WD types/services), the one or more thresholds are set such that switching from power-saving SS occurs sooner and/or the switching to power-saving SS occurs later than that for WD type/services that require greater latency and/or have jitter requirements of a lesser stringency than the certain stringency.

In some embodiments, the network node 16 switches the SS configuration of the WD to a non-power saving SS configuration and maintains the SS configuration irrespective of the one or more thresholds for power saving adaptation mechanisms based on a WD type, WD traffic type and/or service requirements. In some embodiments, the network node 16 may not configure the WD with a power saving SS configuration, including a switching mechanism between a power saving SS configuration and a non-power saving SS configuration for the WD while the WD is experiencing a poor link coverage (e.g., low signal-to-noise ratio (SNR), many retransmissions, power limitations, etc.) at a level such that that the WD traffic and/or service requirements (e.g. latency, QoS, jitter, etc.) cannot be met.

In some embodiments, the network node 16 does not immediately instruct the WD 22 to perform an SS configuration change based on the DRB status in accordance with embodiments of the present disclosure, but the network node 16 instructs the WD 22 to perform the SS configuration change after a certain duration of time, in order to avoid excessive switching back and forth between SS configurations. In some embodiments, the certain duration of time may be, e.g., 10 ms, or 10 slots, or 40 symbols, or any other suitable duration.

Furthermore, it should be appreciated that, for certain devices and/or use cases, no search space switching may be desired. For example, in some embodiments, for latency sensitive communications (i.e. those that are to be received by a UE within a certain time limit), no power saving is implemented for a UE, and the UE is configured with a dense SS without any switching. As an example, if a DRB for Voice over 5G New Radio (VoNR) is configured, a WD may be instructed to switch to dense SS immediately, and no switching to sparse SS may be allowed.

Accordingly, in some implementations, a network node does not perform switching the SS configuration of the WD to a power saving SS configuration or does not configure the WD with a power saving SS configuration. In some embodiments, the network node may switch from a power saving SS configuration and a non-power saving SS configuration for a certain WD types, WD traffic type and/or service requirement(s). The WD type, WD traffic and/or service requirement may not benefit from power saving (e.g., Fixed Wireless Access), require a low latency traffic (e.g., lower latency than latency induced by SS configuration change), and/or have stringent jitter requirements (e.g., more stringent than can be served if SS switching is involved).

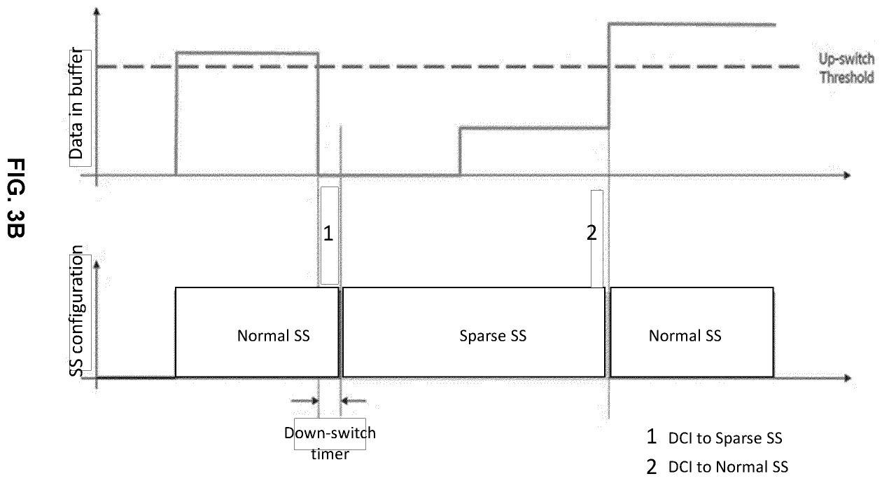

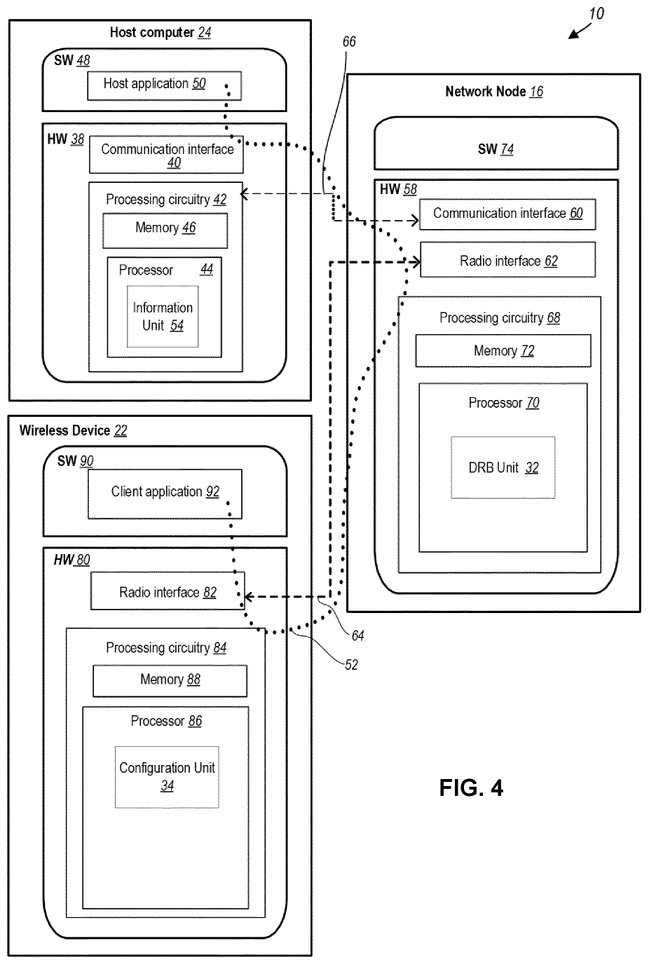

Example implementations, in accordance with some embodiments, of the WD 22, the network node 16, and the host computer 24 will now be described with reference to FIG. 4. In the communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In some embodiments, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to determine, analyze, provide, forward, relay, transmit, receive, store, etc. information relate to at least one power saving configuration during data radio bearer (DRB) inactive.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include DRB unit 32 configured to perform one or more network node 16 functions as described herein such as with respect to at least one power saving configuration during data radio bearer (DRB) inactive.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a configuration unit 34 configured to perform one or more wireless device 22 functions as described herein such as with respect to at least one power saving configuration during data radio bearer (DRB) inactive.

In some embodiments, the inner workings of the network node 16, WD 22, and host computer 24 may be as shown in FIG. 4 and independently, the surrounding network topology may be that of FIG. 1A or FIG. 1B.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1B and 3 show various “units,” such as DRB unit 32 and configuration unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

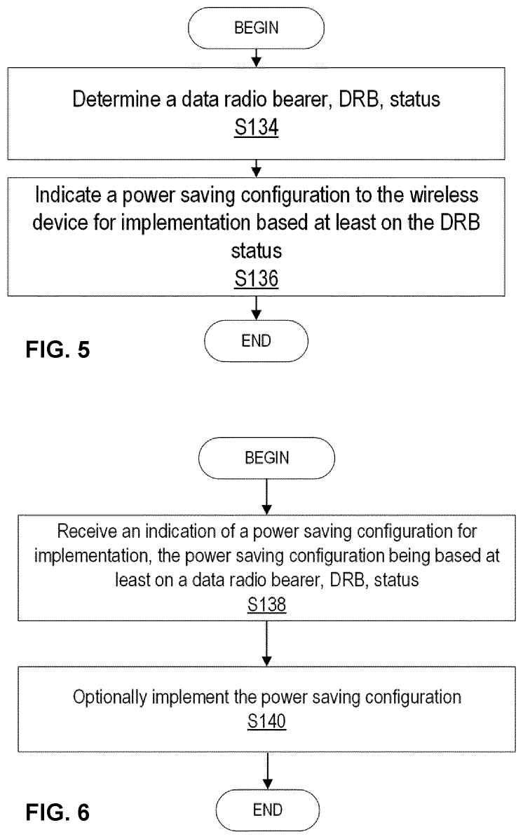

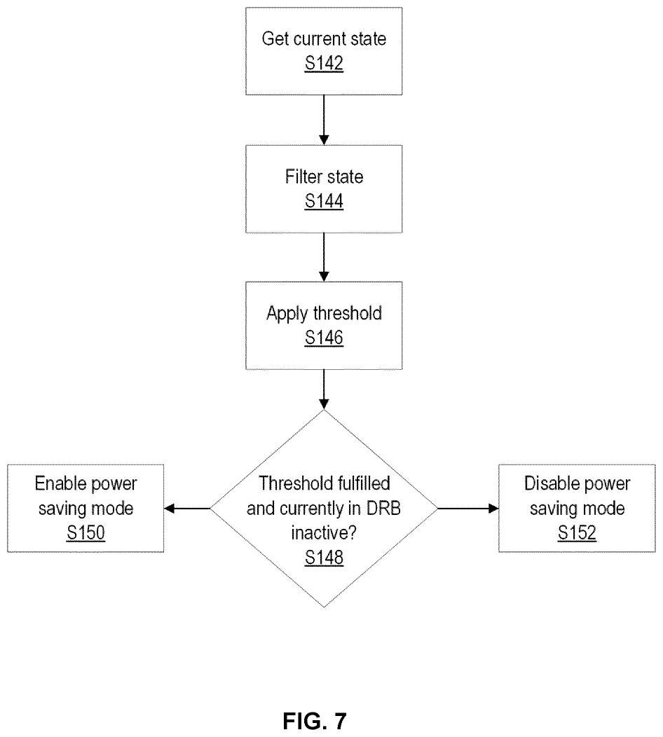

FIG. 5 is a flowchart of an example process in a network node 16 according to some embodiments of the present disclosure. One or more Blocks and/or functions performed by network node 16 may be performed by one or more elements of network node 16 such as by DRB unit 32 in processing circuitry 68, processor 70, radio interface 62, etc. In one or more embodiments, the network node 16, such as via one or more of processing circuitry 68, processor DRB unit 32, communication interface 60 and radio interface 62, is configured to determine (Block S134) a data radio bearer, DRB, status, as described herein. In one or more embodiments, the network node 16, such as via one or more of processing circuitry 68, processor DRB unit 32, communication interface 60 and radio interface 62, is configured to indicate (Block S136) a power saving configuration to the wireless device for implementation based at least on the DRB status, as described herein.

According to one or more embodiments, the processing circuitry is further configured to: determine a DRB metric based at least on the DRB status, and determine whether the DRB metric meets a predefined criterion, the indication of the power saving configuration being based at least on the DRB metric meeting the predefined criterion, as described herein. According to one or more embodiments, the DRB metric is one of a DRB inactivity ratio and DRB status inactive duration, as described herein. According to one or more embodiments, the power saving configuration includes one of: a control signaling transmission configuration to avoid triggering TAT; a reconfiguring connected mode-Discontinuous Reception (C-DRX) parameters; a physical downlink control channel (PDCCH) monitoring occasion/search space (MO/SS) reconfiguration; a wake-up signal (WUS) configuration; a secondary cell (Scell) dormancy or activity status indication; a multiple-input multiple-output (MIMO) layers reconfiguration; a cross-slot scheduling reconfiguration; a bandwidth (BW) reconfiguration; and a channel state information (CSI) reporting rate reconfiguration, as described herein.

FIG. 6 is a flowchart of an exemplary process in a wireless device 22 according to some embodiments of the present disclosure. One or more Blocks and/or functions performed by wireless device 22 may be performed by one or more elements of wireless device 22 such as by configuration unit 34 in processing circuitry 84, processor 86, radio interface 82, etc. In one or more embodiments, the wireless device, such as via one or more of processing circuitry 84, processor 86, configuration unit 34 and radio interface 82 is configured to receive (Block S138) an indication of a power saving configuration for implementation, the power saving configuration being based at least on a data radio bearer, DRB, status, as described herein. In one or more embodiments, the wireless device, such as via one or more of processing circuitry 84, processor 86, configuration unit 34 and radio interface 82 is configured to optionally implement (Block S140) the power saving configuration, as described herein.

According to one or more embodiments, the power saving configuration includes one of: a control signaling transmission configuration to avoid triggering TAT; a reconfiguring connected mode-Discontinuous Reception (C-DRX) parameters; a physical downlink control channel (PDCCH) monitoring occasion/search space (MO/SS) reconfiguration; a wake-up signal (WUS) configuration; a secondary cell (Scell) dormancy or activity status indication; a multiple-input multiple-output (MIMO) layers reconfiguration; a cross-slot scheduling reconfiguration; a bandwidth (BW) reconfiguration; and a channel state information (CSI) reporting rate reconfiguration, as described herein. According to one or more embodiments, the indication is received in higher layer signaling, as described herein.

Having generally described arrangements for at least one power saving configuration during data radio bearer (DRB) inactive, details for these arrangements, functions and processes are provided as follows, and which may be implemented by the network node 16, the wireless device 22 and/or the host computer 24.

Embodiments in accordance with the present disclosure provide at least one power saving configuration during data radio bearer (DRB) inactive. One or more embodiments described herein provide one or more mechanisms, methods and/or processes for power saving (e.g., wireless device 22 power savings) in situations where DRB is not being actively used, i.e., inactive, in an NR receiver such as if there is no, little, or low ongoing traffic. This may include the 6

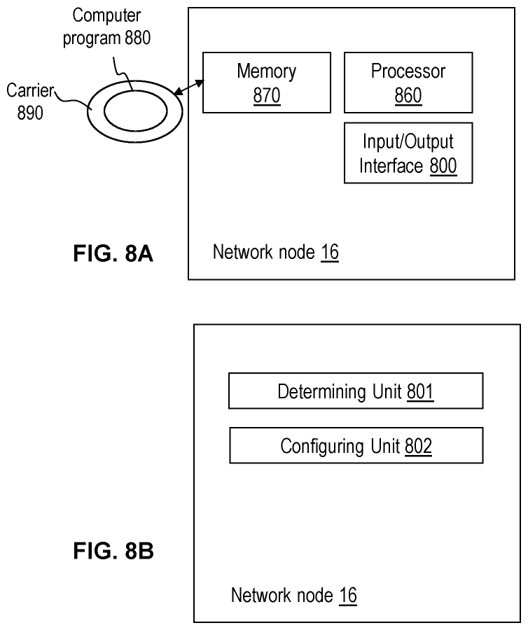

In some embodiments, to perform various method actions described above, the network node 16 is configured to communicate with the wireless device 22. The network node 16 may comprise an arrangement depicted in FIGS. 8A and 8B.

As shown in FIG. 8A, the network node 16 may comprise an input and output interface 800 configured to communicate with UEs or WDs such as the WD 22 and/or WD 23, and the WD 22 is referred to below by way of example. The input and output interface 800 may comprise a wireless receiver (not shown) and a wireless transmitter (not shown).

The network node 16 may be configured to, e.g. by means of a determining unit 801 in the network node 16, determine a DRB status of the WD 22.

In some embodiments, the network node 16 may further be configured to, e.g. by means of the determining unit 801 in the network node 16, determine one or more bandwidth parts, BWPs, and/or one or more search space, SS, configurations of one or more BWPs for the WD 22 based on the DRB status.

In some embodiments, the network node 16 may further be configured to, e.g. by means of the determining unit 801 in the network node 16, determine the one or more SS configurations using one or more criteria that comprise one or more out of:
a DL buffer occupancy of the WD 22 in the network node 16;
a total DL buffer occupancy in the network node 16 of WDs which the network node 16 is serving;
a UL buffer occupancy of the WD 22;
a buffer occupancy in the network node 16 of another WD in a communication system comprising the network node 16 and the WD 22;
an energy consumption of the WD 22;
DL and/or UL radio resource consumption; a
scheduling delays;
at least one time division duplex, TDD, configuration and/or at least one TDD pattern used in a DL and/or a UL in the one or more BWPs.

In some embodiments, the network node 16 determines the DRB status, e.g., by means of the determining unit 801, at least in part based on a buffer occupancy of the WD 22, the DRB status is inactive when the buffer occupancy of the WD 22 is zero or less than a threshold, and the DRB status is active when the buffer occupancy of the WD 22 is not zero or greater than the threshold.

In some embodiments, the buffer occupancy of the WD 22 is a DL buffer occupancy of the WD 22 in the network node 16 and/or a UL buffer occupancy of the WD 22.

In some embodiments, the network node 16 determines, e.g., by means of the determining unit 801, the DRB further by determining a second threshold, and wherein, when the buffer occupancy of the WD 22 is greater than the second threshold, the DRB status is active.

In some embodiments, the network node 16 determines, e.g., by means of the determining unit 801, the DRB status at least in part based on a DRB inactivity ratio of the WD 22. In such embodiments, the DRB status is inactive when the DRB inactivity ratio of the WD 22 is above a third threshold, and the DRB status is active when the DRB inactivity ratio of the WD 22 is below the third threshold.

In some embodiments, any one or more out of the threshold, the second threshold, and the third threshold are determined based on a WD type, a WD traffic type, and/or a service requirement.

In some embodiments, one or more out of the threshold, the second threshold, and the third threshold are adjustable.

The network node 16 may further be configured to, e.g. by means of a configuring unit 802 in the network node 16, when the DRB status is inactive, enable a power saving mode for the WD 22 by configuring the WD 22 with an SS configuration from the determined one or more SS configurations of the one or more BWPs for the WD 22 based at least on the DRB status. The network node 16 may further be configured to, e.g. by means of the configuring unit 802 in the network node 16, when the DRB status is active, disable the power saving mode or not enabling the power saving mode.

The network node 16 may further be configured to, e.g. by means of the configuring unit 802 in the network node 16, configuring the WD 22 with the SS configuration by:
determining a physical downlink control channel (PDCCH) monitoring occasion (MO) configuration associated the SS configuration; and/or
determining at least one BWP having the SS configuration.

In some embodiments, the network node 16 may further be configured to, e.g. by means of the configuring unit 802 in the network node 16, disable the power saving mode or not enabling the power saving mode by configuring the WD 22 with a different SS configuration of the one or more BWPs for the WD 22. In some embodiments, the one or more BWPs and/or the one or more SS configurations relate to a WD type, a WD traffic type, and/or a service requirement.

In some embodiments, the PDCCH MO of the SS configuration used when the DRB status is inactive is sparser than a PDCCH MO of an SS configuration used when the DRB status is active, and the network node 16 configures the WD 22, e.g. by means of the configuring unit 802, with an offset value such that the PDCCH MO used when DRB status is inactive is non-overlapping with the PDCCH MO used by another WD served by the same network node. In some embodiments, the offset value comprises an offset in frequency and/or time. In some embodiments, the WD 22 and the another WD have an inactive DRB status.

In some embodiments, the network node 16 may further be configured to, e.g. by means of the configuring unit 802, determine configuration of parameters related to SS-group switch in a manner that improves power saving for the WD, as discussed in more detail below. The configuration of the parameters may include one or more out of a number of SS-groups; an S S-group's SS periodicity, offset, and duration; an SS-group index; an SS-group switching timer, etc. The configuring may be performed for SS adaptation, using e.g. an SS-group switching mechanism. In some embodiments, the configuring is performed for BWP switching-based SS adaptation.

The embodiments herein may be implemented through a respective processor or one or more processors, such as a processor 860 of a processing circuitry in the network node 16 depicted in FIG. 8B, together with respective computer program code for performing the functions and actions of the embodiments herein. The program code mentioned above may also be provided as a computer program product, for instance in the form of a data carrier carrying computer program code for performing the embodiments herein when being loaded into the network node 16. One such carrier may be in the form of a CD ROM disc. It is however feasible with other data carriers such as a memory stick. The computer program code may furthermore be provided as pure program code on a server and downloaded to the network node 16.

The network node 16 may further comprise a memory 870 comprising one or more memory units. The memory 870 comprises instructions executable by the processor in the network node 16. The memory 870 is arranged to be used to store e.g. information, indications, data, configurations, and applications to perform the methods herein when being executed in the network node 16.

In some embodiments, a computer program 880 comprises instructions, which when executed by the respective at least one processor 860, cause the at least one processor of the network node 16 to perform the actions above.

In some embodiments, a respective carrier 890 comprises the respective computer program 880, wherein the carrier 890 is one of an electronic signal, an optical signal, an electromagnetic signal, a magnetic signal, an electric signal, a radio signal, a microwave signal, or a computer-readable storage medium.

Those skilled in the art will appreciate that the units in the network node 16 described above may refer to a combination of analog and digital circuits, and/or one or more processors configured with software and/or firmware, e.g. stored in the network node 16, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

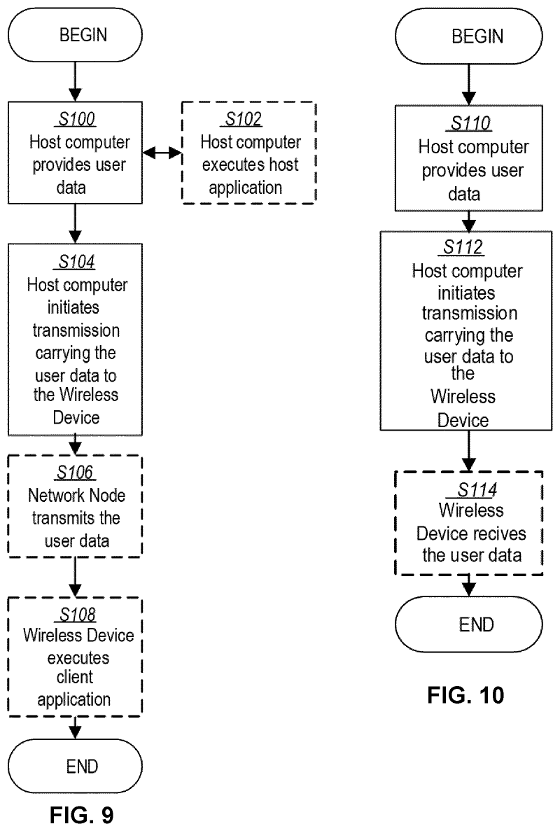

FIG. 9 is a flowchart illustrating an exemplary method implemented in a communication system, such as, for example, the communication system of FIGS. 1A, 1B and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 10 is a flowchart illustrating an exemplary method implemented in a communication system, such as, for example, the communication system of FIGS. 1A and 1B, in accordance with one embodiment. The communication system may include a host computer 24, a network node 16 and a WD 22, which may be those described with reference to FIGS. 1A, 1B and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

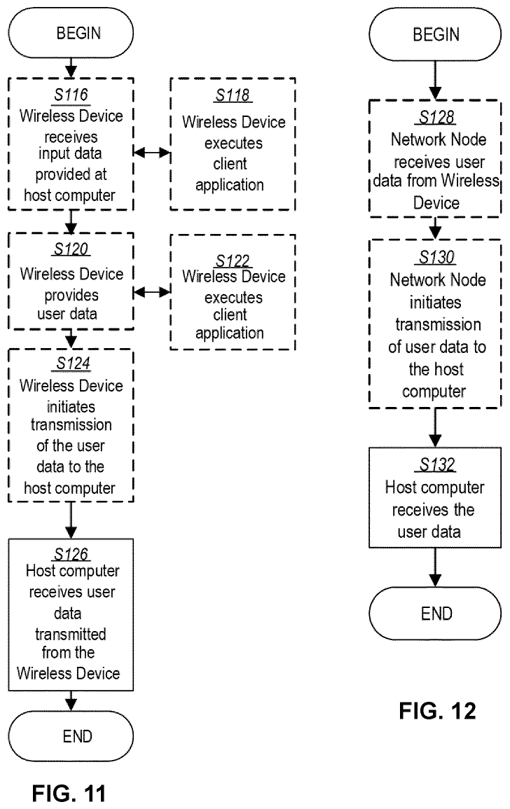

FIG. 11 is a flowchart illustrating an exemplary method implemented in a communication system, such as, for example, the communication system of 1A and 1B, in accordance with one embodiment. The communication system may include a host computer 24, a network node 16 and a WD 22, which may be those described with reference to FIGS. 1A, 1B and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 12 is a flowchart illustrating an exemplary method implemented in a communication system, such as, for example, the communication system of FIGS. 1A and 1B, in accordance with one embodiment. The communication system may include a host computer 24, a network node 16 and a WD 22, which may be those described with reference to FIGS. 1A, 1B, and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

Various aspects of embodiments in accordance with the present disclosure are described below. One or more of the aspects can be combined in various way in embodiments in accordance with the present disclosure.

Aspect 1: Avoiding Triggering IAT During NR DRB Inactive

It may be assumed that the wireless device 22 is configured with a C-DRX consisting of one or more of a specific C-DRX cycle, an ON duration, and non-zero IAT.

IAT can potentially account for a significant portion of wireless device 22 power consumption during the connected mode. An NR wireless device 22 may trigger IAT if a new transmission is scheduled, indicating new data such as via NDI. In some embodiments, the network node 16 can avoid or reduce a quantity of scheduling the wireless device 22 with new transmissions during DRB Inactive (e.g., avoid scheduling new non-data related transmissions) such that the wireless device 22 does not trigger IAT.

For example, although no data is going to be scheduled for the wireless device 22, if the network node 16 requests BSR, which is considered as a new transmission by the wireless device 22, IAT is triggered; therefore, the network node 16 may avoid such transmission in order to avoid triggering IAT. That is, the network node 16, such as via one or more of processing circuitry 68, processor 70, radio interface 62, DRB unit 32, etc., refrains from requesting BSR during DRB inactive as much as possible. For example, the network node 16, such as via one or more of processing circuitry 68, processor 70, radio interface 62, DRB unit 32, etc., may reduce the rate of BSR requests to the lowest rate satisfying quality of service (QoS) requirements of ongoing wireless device 22 services, or some default QoS assumptions/thresholds. In another example, particularly when the NR wireless device 22, such as via one or more of processing circuitry 84, processor 86, radio interface 82, configuration unit 34, etc., operates in a non-standalone (NSA) mode, the network node 16 can request the BSR on the LTE leg to avoid triggering IAT on the NR leg.

In one or more embodiments, if the network node 16 needs to transmit a BSR request on NR during DRB inactive, the BSR request transmitted by the network node 16 may be followed by a MAC CE GTS command to terminate the IAT.

In one or more embodiments, the network node 16, such as via one or more of processing circuitry 68, processor 70, radio interface 62, DRB unit 32, etc., can reconfigure the wireless device 22 with a shorter IAT (e.g., lower/smaller duration than an ON duration, or a few ms) depending on a criterion. For example, if the ratio of DRB inactive duration versus DRB active duration of a wireless device 22 raises above a specific threshold, the wireless device 22 is configured with a shorter IAT, but if the ratio falls below the threshold, the wireless device 22 is configured by a longer IAT.

Aspect 2: Reconfiguring C-DRX Parameters

It may be assumed that the wireless device 22 is configured with a C-DRX including a specific C-DRX cycle, an ON duration length, and an IAT length. In one example, the network node 16, such as via one or more of processing circuitry 68, processor 70, radio interface 62, DRB unit 32, etc., may consider different C-DRX configurations for the wireless device 22 based at least on the expected or current DRB inactive duration or the ratio of DRB inactive time to DRB active time, denoted by DRB inactivity ratio from here on. Alternatively, the ratio may be defined as the fraction of DRB inactive time out of the total time. For example, in a binary configuration, if a criterion is met such as the DRB inactivity ratio or DRB inactive duration being above a threshold, the wireless device 22 is configured with a different, more PS-oriented C-DRX than the default C-DRX which applies when DRB inactivity ratio or DRB inactive duration is below or equal to the threshold, i.e., when a criterion is not met. The different C-DRX configuration may entail a shorter ON duration, or a shorter IAT, or a longer C-DRX cycle, or a combination two or more of them. The network node 16 may also consider a finer granularity, e.g., define multiple thresholds instead of only one, and more than two CDRX configurations, to achieve a better wireless device 22 power and throughput efficiency for example.

In cases where the wireless device 22 is configured with carrier aggregation on the secondary cell group (SCG) which is in a DRB inactive state, the network node 16, such as via one or more of processing circuitry 68, processor 70, radio interface 62, DRB unit 32, etc., can configure the wireless device 22 with two different DRX groups: a primary and a secondary DRX group. The primary group may be configured with as few cells as possible (e.g., 1 cell) with a shorter DRX cycle compared to the DRX cycle of the remaining cells configured to belong to a secondary DRX group. Furthermore, the cell(s) of the primary group may be chosen such that the associated operations in the wireless device consume less power than the cell of the secondary DRX group, e.g., the primary cell may be deployed on lower frequency. As such, excessive application delays are avoided in case there is imminent DRB activity again, since there is at least one cell available for communication on cell(s) of primary group with shorter DRX cycle instead of having long DRX cycle for all of the cells.

In the examples above, the network node 16, such as via one or more of processing circuitry 68, processor 70, radio interface 62, DRB unit 32, etc., may reconfigure the wireless device 22 with a different C-DRX configuration, using, e.g., higher layer signaling such as RRC reconfiguration signaling.

In some embodiments, if the traffic patterns of the wireless device 22 lead to extended DRB active and DRB inactive times, without frequent state changes, the network node 16, such as via one or more of processing circuitry 68, processor 70, radio interface 62, DRB unit 32, etc., may RRC-reconfigure the wireless device 22 with a cDRX configuration tailored to the state it enters at each state change, where the configurations are formulated according to the same principles as described above—shorter onDuration and IAT and longer cycle for DRB inactive, etc.

Aspect 3: PDCCH MO/SS Reconfiguration

The wireless device 22 may be configured with one or more PDCCH candidate monitoring occasions (Mos or MOs) associated with one or more search space (SS) configurations. In one or more embodiments, the wireless device 22 may be configured with two or more PDCCH monitoring configuration groups. More specifically, one group can have a lower frequency of PDCCH MOs (sparser monitoring) and/or shorter duration than the other one. In such a case, the wireless device 22 may be indicated by the network node 16 to move to a different PDCCH monitoring configuration group.

Furthermore, the wireless device 22 may have been configured with different SS configurations in different bandwidth parts (BWPs). For example, the wireless device 22 may be configured with a sparser SS in one BWP, (e.g., a SS periodicity of 2 slots or more), and a denser SS in another BWP (e.g., SS periodicity of 1 slot).

In addition, for the above two options (using SS-group switch and BWP switch), the network node 16 may also consider setting the SS periodicity of the sparser SS based at least on the periodicity of the periodic measurement (e.g., periodic CSI-RS).

In one example, the network node 16, such as via one or more of processing circuitry 68, processor 70, radio interface 62, DRB unit 32, etc., reconfigures the wireless device 22 (e.g., via higher layer signaling such as RRC reconfiguration) with a higher SS periodicity (e.g., SS periodicity of 2 slots or more with respect to SS periodicity of 1), or a lower SS duration (e.g., a duration of 1 with respect to two or more), if DRB inactivity ratio or DRB inactive duration goes above a threshold.

In another example, if the DRB inactivity ratio or DRB inactive duration goes above a threshold, the network node 16, such as via one or more of processing circuitry 68, processor 70, radio interface 62, DRB unit 32, etc., indicates the wireless device 22 to move to a first pre-configured SS configuration, and if the DRB inactivity ratio or DRB inactive duration goes below a threshold, the network node 16, such as via one or more of processing circuitry 68, processor 70, radio interface 62, DRB unit 32, etc., indicates the wireless device 22 to move to a second pre-configured SS configuration. For example, the wireless device 22 may be indicated to change the active BWP to one with a sparser SS configuration, or to a PDCCH configuration group with sparser SS for a low DRB inactivity ratio.

In another example, if the current DRB inactive duration goes above a threshold (i.e., an example of a criterion) while the wireless device 22 is in active time, e.g., during an on-going IAT, the network node 16, such as via one or more of processing circuitry 68, processor 70, radio interface 62, DRB unit 32, etc., may command the wireless device 22 to leave active time through a go to sleep signal (GTS), e.g., via MAC-CE command.

Since the network node 16 expects that it is unlikely that the wireless device 22 is soon going to be scheduled (i.e., an example of a criterion), in one or more embodiments, the network node 16, such as via one or more of processing circuitry 68, processor 70, radio interface 62, DRB unit 32, etc., configures the PDCCH search space such that the number of blind decodes for the wireless device 22 is decreased.

In one or more embodiments, the wireless device 22 is configured with a large aggregation level, larger than would otherwise be necessary or needed by the wireless device 22 given one or more existing wireless device 22 parameters and/or operation. Since the scheduling of the wireless device 22 is unlikely, the larger system resources associated by the higher aggregation level may, in practice, not be used, but the larger AL may make it easier to decode PDCCH with fewer antennas, or a more power efficient radio configuration. The configuration of a large AL to a wireless device 22 which has previously reported a good CSI (i.e., CSI meet a predefined CSI criterion) may also serve as an indication that the wireless device 22 can relax its receiver settings.

Aspect 4: Wake-Up Signal (WUS) Configuration

The wireless device 22 may have the capability to be configured with a WUS (e.g., a DCI based WUS) potentially associated with a C-DRX configuration (e.g., the WUS is configured a few slots or ms before ON duration). As such, e.g., the wireless device 22, such as via one or more of processing circuitry 84, processor 86, radio interface 82, configuration unit 34, etc., is expected to monitor PDCCH in the upcoming ON duration if the WUS indicates the wireless device 22 to wake-up and monitor PDCCH.

In one example, the network node 16, such as via one or more of processing circuitry 68, processor 70, radio interface 62, DRB unit 32, etc., may decide to configure the wireless device 22 with the above mentioned WUS mechanism, if the DRB inactivity ratio or DRB inactive duration goes above a specific threshold (i.e., an example of a predefined criterion). Otherwise, the network node 16 may refrain from configuring the WUS. In some embodiments, the network node 16, such as via one or more of processing circuitry 68, processor 70, radio interface 62, DRB unit 32, etc., may switch the wireless device 22 between two BWPs, one configured with WUS and the other without, which reduces switching delay. In another embodiment, the WUS configuration is changed via RRC reconfiguration.

Additionally, within the WUS mechanism, the network node 16, such as via one or more of processing circuitry 68, processor 70, radio interface 62, DRB unit 32, etc., may have the option to configure the wireless device 22 with a specific operation when WUS is not detected. For example, it may be possible to configure that action if WUS is not detected—in order to configure the wireless device 22 monitor PDCCH in the upcoming ON duration or not. In one example, the network node 16 configures the wireless device 22 with a WUS, but if DRB inactivity ratio or DRB inactive duration goes above a specific threshold (i.e., an example of a predefined criterion), the network node 16, such as via one or more of processing circuitry 68, processor 70, radio interface 62, DRB unit 32, etc., further configures the wireless device 22 to not wake-up if WUS is not detected, or if the DRB inactivity ratio or DRB inactive duration falls below the threshold (i.e., an example of a predefined criterion), the network node 16, such as via one or more of processing circuitry 68, processor 70, radio interface 62, DRB unit 32, etc., configures the wireless device 22 to always wake-up if WUS is not detected, or regardless of whether WUS is detected.

Aspect 5: Scell Dormancy or Activity Status Indication

It is assumed in one or more embodiments of this aspect that the wireless device 22 is configured with one or more Scells, and further, the wireless device 22 may have the capability to implement Scell dormancy like behavior. For the latter, the wireless device 22 may be further configured with a specific Scell dormancy-like indication by the network node 16.

In one approach, if the DRB inactivity ratio or DRB inactive duration goes above a threshold (i.e., an example of a predefined criterion), the network node 16, such as via one or more of processing circuitry 68, processor 70, radio interface 62, DRB unit 32, etc., indicates to the wireless device 22 to deactivate the Scell (if it is active), e.g., via MAC CE commands. Alternatively, the network node 16, such as via one or more of processing circuitry 68, processor radio interface 62, DRB unit 32, etc., may indicate to the wireless device 22 to operate in Scell dormancy mode, i.e., the wireless device 22 does not need to monitor PDCCH on the Scell. Such an indication can be provided via, e.g., an explicit Scell dormancy indication, e.g., in DCI formats 0-1 and 1-1, or via implicit techniques, such as switching the wireless device 22 to a BWP with a large SS periodicity, or a BWP with no PDCCH MOs configured.

Furthermore, if the wireless device 22 is configured with cross-carrier scheduling, a sufficiently large offset between a scheduling PDCCH and PxSCH can be considered to enable the scheduled CC to remain in sleep mode when nothing is expected to be scheduled.

In a related embodiment, the network node 16 may deactivate Scells if the DRB inactivity ratio or DRB inactive duration goes above a threshold (i.e., an example of a predefined criterion). This also reduces CSI-RS measurements and reporting activity, in addition to PDCCH monitoring reduction achieved via dormancy.

Aspect 6: MIMO Layers Reconfiguration

It is assumed in one or more embodiments of this aspect that the wireless device 22 has the capability to be configured with a specific maximum number of layers per cell or per BWP.

In one example, if the DRB inactivity ratio or DRB inactive duration goes above a threshold (i.e., an example of a predefined criterion), the network node 16, such as via one or more of processing circuitry 68, processor 70, radio interface 62, DRB unit 32, etc., reconfigures the wireless device 22 with a lower number of MIMO layers. The reconfiguration can be performed, e.g., via higher layer signaling such as RRC reconfiguration of per cell or per BWP maximum number of MIMO layers, or via DCI signaling. The latter can be realized by switching the wireless device 22 through a DCI to a BWP with lower number of layers.

Aspect 7: Cross-Slot Scheduling Reconfiguration

It is assumed in one or more embodiments of this aspect that the wireless device 22 can be configured with a cross-slot scheduling mode (i.e., a non-zero slot offset between a scheduling PDCCH and the upcoming operation, e.g., PxSCH, CSI-report, and SRS transmission).

In one example, if the DRB inactivity ratio or DRB inactive duration goes above a threshold (i.e., an example of a predefined criterion), the network nodes 16, such as via one or more of processing circuitry 68, processor 70, radio interface 62, DRB unit 32, etc., configures the wireless device 22 with a cross-slot scheduling mode, allowing the wireless device 22 to save power by avoiding PDSCH buffering, or applying a low power PDCCH receiver. The cross-slot scheduling mode configuration can be performed, e.g., through RRC reconfiguration by excluding a zero offset, or by explicit indication through a DCI, e.g., as in NR 3GPP Release 16 DCI format 1-1 and 0-1.

Aspect 8: BW Reconfiguration

It is assumed in one or more embodiments of this aspect that the wireless device 22 has the possibility to be configured with two or more BWPs with different BWs. As such the network node 16, such as via one or more of processing circuitry 68, processor 70, radio interface 62, DRB unit 32, etc., may configure the wireless device 22 with at least two BWPs, with one having lower BW than the other one.

In one example, if DRB inactivity ratio or DRB inactive duration goes above a threshold (i.e., an example of a predefined criterion), the network node 16, such as via one or more of processing circuitry 68, processor 70, radio interface 62, DRB unit 32, etc., indicates the wireless device 22, e.g., through DCI signaling to move to the BWP with the lower BW to save power by operating in a lower BW.

In cases where the wireless device 22 does not support BWP switching capability, the network node 16 can reconfigure the wireless device 22 via RRC reconfiguration within a BWP with a lower BW.

Aspect 9: Adapting Wireless Device 22 Operation to DRB Active Status without Additional Signaling

In the above aspects, the examples describe how the network node 16, such as via one or more of processing circuitry 68, processor 70, radio interface 62, DRB unit 32, etc., indicates the wireless device 22 to change configurations through explicit signaling, e.g., DCI command. In one or more embodiments, the network node 16, such as via one or more of processing circuitry 68, processor 70, radio interface 62, DRB unit 32, etc., implicitly indicates the change through timer mechanism, e.g., BWP-inactive timer, SS-switch timer, etc. Here, the timer can be set to be equal to the threshold of the DRB inactive duration. For example, if the network node 16 determines to switch the wireless device 22 to the sparser BWP such as if the DRB inactive duration reaches x ms (i.e., an example of a predefined criterion), then the network node 16 can configure the wireless device 22 with a BWP-inactive timer of x ms.

Aspect 10: Determining the Threshold for Power Saving Adaptation Mechanisms

One or more of the above described aspects enable wireless device 22 operation in a power saving mode when the network node 16 is operating in a DRB inactive mode. The metric and threshold used when enabling the power saving mode can vary. For example, a switch can be triggered as soon as the network node 16, such as via one or more of processing circuitry 68, processor 70, radio interface 62, DRB unit 32, etc., enters DRB inactive; or when the DRB inactive has been present for a certain duration; or when the network node 16 is in DRB inactive and determines (either by previous estimates of DL traffic patterns, or by design of DRB inactive length) that the DRB inactive will continue for a certain amount of time.

Similarly, the DRB inactive state indication can be filtered (e.g., with AR/MA filter coefficients), to give a metric representing, e.g., the DRB inactivity ratio, the fraction of time during a recent time interval, the DRB inactive has been present. A filtered metric may then be combined with the current state, such that the power saving is enabled if both the long-term metric is fulfilled and the state currently is DRB inactive.

Further, the metric obtained may be compared to a threshold. The threshold may be different for different wireless devices 22 or groups of wireless devices 22, e.g., based at least on the latency requirements for a certain wireless device 22, or the importance/necessity of power saving for a certain wireless device 22. The thresholds can also be different between different methods of wireless device 22 power saving configurations (in aspects 1-8 above), dependent on the amount of power saving obtained by the method, and the cost in terms, e.g., of signaling overhead or increased latency.

Different thresholds may be used for entering and leaving the power saving configurations, as a form of hysteresis. Also, several of the described methods/aspects can be combined, possibly triggered by different metrics or thresholds.

Aspect 11: Obtaining DRB Active/Inactive Status Information

DRB active/inactive status is a higher-layer descriptor and may not be available at the MAC and PHY layers where the wireless device 22 PS measures described herein are applied. In one or more embodiments, the status information is passed to MAC/L1 control within a network node 16 or between multiple network nodes 16 in the network. Based at least on the status information, the MAC/PHY layer adapts their behavior towards the wireless device 22 autonomously. For example, the wireless device 22 may be immediately provided with GTS commands (e.g., MAC-CE DRX command of aspect 1 or any other GTS-type command from layer1 based at least on search space or BWP switch, e.g., aspect 3) after any activity that would invoke IAT. The exception may be when the wireless device 22 transmits scheduling request/UL data which would change the status to DRB active. Similarly, based at least on such information, layer1 could adapt its aperiodic CSI report request rate. For example, in a DRB inactive state, the rate of requests may be reduced compared to the DRB active state.

In various embodiments of the present disclosure, aspects are being presented that disclose network logic and decision criteria for configuring and performing SS adaptation, using e.g. an SS-group switching mechanism. The logic may also be applied to BWP switching-based adaptation.

In some aspects, a method that can be performed by the network node to determine the configuration of the parameters related to SS-group switch, so that it could be beneficial for power saving, is presented. The configuration of the parameters includes the number of SS-group; the SS-group's SS periodicity, offset, and duration; the SS-group index; the SS-group switching timer, etc.

In some aspects, a method is described that can be used by the network node to determine whether a UE or WD, e.g., the WD 22 or WD 23, should or should not switch its SS-group, including to switch from one SS-group to the other SS-group or to remain in the current SS-group. In addition, it also presents the methods for scheduler prioritization given the SS configuration.

Some advantages of the various embodiments of the present disclosure are that the embodiments enable the network node to exploit the SS-group switch feature for UE power saving purposes to reduce the number of PDCCH monitoring that has to be done by the UE.

In various embodiments, operations by a network node in a communication system include configuring, for a WD 22, parameters for at least two monitoring patterns and a switching criterion controlling the WD 22 switching between the at least two monitoring patterns. The operations by the network node 16 also include sending a first communication to the WD 22 indicating the parameters for the at least two monitoring patterns, and sending a second communication to the WD 22 indicating which monitoring pattern the UE should operate (i.e., indicate which parameters of which one of the at least two monitoring patterns the UE should operate using) based on the switching criteria.

In some embodiments, the first communication comprises a scheduling message. In some embodiments, the first communication comprises a downlink control information (DCI) message.

In some embodiments, the at least two monitoring patterns correspond to different search space (SS) groups the WD 22 is to switch between to monitor for a DCI message.

In some embodiments, the configuration for the WD 22 of the parameters for the at least two monitoring patterns includes defining at least one of the following for each of the at least two monitoring patterns: a monitoring pattern number; a monitoring pattern periodicity; a monitoring pattern offset; a monitoring pattern duration; a monitoring pattern index; and a monitoring pattern switching timer.

In some embodiments, the at least two monitoring patterns include a first monitoring pattern and a second monitoring pattern, where the first monitoring pattern is denser in time and/or frequency than the second monitoring pattern.

Below, methods and operations that can be used by the network node, such as, e.g., the network node 16, to set the configuration for the WD 22 in relation to SS-group switch, are described. In addition, methods and operations that can be used by the network node to initiate the SS-group switch based on several criteria are described. In the present disclosure, the terms and the parameters in the SS-group switch are generic, i.e., including without limitation SS-group switch standardized in Rel. 16. In addition, the term SS-group may be called differently in 3GPP standards, e.g. SS-set. Note also that the term SS-group may not necessarily require more than one SS in that group.

Various embodiments below are also applicable to SS switching using the BWP switching mechanism. In that case, an SS-group should be interpreted as one or more S Ss configured in the BWP with a given (group) index. A subset or a part of total carrier bandwidth is referred to as bandwidth part (BWP). A BWP forms a set of contiguous common resource blocks (CRBs) within the full carrier bandwidth. In other words, within the carrier bandwidth, a BWP starts at a CRB and spans over a set of consecutive CRBs.

Search Space Configuration Preference Aspect

In this aspect, factors and methods that can be used in configuring parameters included in the SS-group switch feature are presented. The parameters of the SS-group switch include the number of SS-group; the SS-group's SS periodicity, offset, and duration; the SS-group index; and the SS-group switching timer, etc.

Determination of the Number of SS-Groups and the Type of SS Patterns

The network node 16 may determine the number of SS-groups based on the number of different monitoring patterns to be supported for the UE, where the possible types of patterns may include dense periodic monitoring, sparse periodic monitoring, single-occasion monitoring (WUS-like), and no monitoring (GTS-like).

In some embodiments, the network node 16 may determine the number of SS-groups by the type of traffic in which the WD 22 is on. For example, for a more fixed traffic type such as voice application, the network node can configure the WD 22 with a single SS-group with a certain periodicity of PDCCH MO. On the other hand, for the case of FTP traffic which is more random (has statistics on its packet inter-arrival time though), the network node may configure the WD 22 with two SS-group, e.g., one group has a denser PDCCH MO pattern (a.k.a. denser SS-group) which is applied during the data burst and another group has a sparser PDCCH MO (a.k.a. sparser SS-group) which is applied e.g. while waiting for a data burst to come in the on-duration or during the IAT. Here, the sparser SS-group can be set as the default SS-group (i.e. SS group0).

The network node 16 may configure the WD 22 to have more than two (e.g. 3, or more than 3) SS-groups, e.g. for the case of very sparse FTP traffic such as instant messaging application. In this case, the first SS-group can have a sparse PDCCH MO, implemented during the CDRX on-duration; the second SS has a dense periodicity, implemented during the data burst; and the third SS has no PDCCH MO implemented after a data burst ends.

In some embodiments, the WD 22 configuration may include an SS with a single PDCCH MO per cDRX cycle if the WD 22 traffic or service type results in a small fraction of on-durations being occupied, and the configuration may include an SS with no MO if the WD 22 traffic or service type results in a single transmissions bursts in on-durations where the WD 22 is scheduled.

Furthermore, as described above, in some embodiments, thresholds in accordance with embodiments of the present disclosure may depend on a WD traffic type.

The network node 16 may also consider the service type used by the WD 22. For example, for the case of the WD 22 using ultra-reliable low latency communication (URLLC) type of service, the network node may simply configure the WD 22 with one SS-group. On the other hand, when the WD 22 applies typical enhanced mobile broadband (eMBB) applications, the network node may configure the WD 22 with one, two, or even three SS-groups based on the traffic type mentioned above. In a related realization, in case the WD 22 may be capable of running several types of services at the same time, each service type can be associated with one or more specific SS-group, or the number of groups may be decided based on the service with most demanding QoS.

The network node 16 may also consider the type of the WD 22 in determining the number of SS-groups, e.g., for eMBB, the network node may consider a larger number of SS-groups, in contrast to a RedCap WD 22 which mostly deals with low data traffic.

In some embodiments, the configuring for the WD 22 of the parameters for the at least two monitoring patterns and the switching criteria controlling the WD 22 switching between the at least two monitoring patterns, includes determining a number of the at least two monitoring patterns to be configured for the WD 22 and the switching criteria based on a type of traffic being communicated from the WD or to the WD.

In some embodiments, the determination of the number of the at least two monitoring patterns to be configured for the WD 22 and the switching criteria based on a type of traffic being communicated from the WD 22 or to the WD 22, includes configuring the parameters for first and second monitoring patterns for FTP type traffic satisfying a threshold level of random sparseness. The first monitoring pattern is denser in time and/or frequency for PDCCH MO than the second monitoring pattern. The switching criteria are configured to have the UE use the parameters for the first monitoring pattern during a data burst and to have the UE use the parameters for the second monitoring pattern while waiting for a data burst to come during an on-duration of the UE.

In some embodiments, the determination of the number of the at least two monitoring patterns to be configured for the WD 22 and the switching criteria based on a type of traffic being communicated from the WD 22 or to the WD 22, configuring the parameters for first, second, and third monitoring patterns for FTP type traffic satisfying a threshold level of sparseness. The first monitoring pattern is sparser in time and/or frequency for PDCCH MO than the second monitoring pattern. The third monitoring pattern has no PDCCH MO. The switching criteria is configured to have the UE use the parameters for the first monitoring pattern during Connected Mode Discontinuous Reception, cDRX, on-duration of the UE, use the parameters for the second monitoring pattern during a data burst, and use the parameters for the third monitoring pattern after the data burst ends.

In some embodiments, the configuring for the WD 22 of a switching criteria controlling the WD 22 switching between the at least two monitoring patterns, includes configuring which criteria of a plurality of switching criteria is used to control switching between which of the at least two monitoring patterns based on at least one of: Connected Mode Discontinuous Reception, cDRX, parameters for communications with the WD 22; carrier aggregation setting for communications with the WD 22; carrier aggregation setting for communications with the WD 22; BWP-switch timer; a defined acceptable delay for communications with the WD 22; and a UE type indication.

In some embodiments, the configuring for the WD 22 of the parameters for the at least two monitoring patterns includes determining a number of the monitoring patterns to be configured for the WD 22 based on a number of different types of services the UE is executing which have a threshold difference between them in required Quality of Service, QoS.

In some embodiments, the configuring for the WD 22 of the parameters for the at least two monitoring patterns is based on at least one of: the UE operating in an unlicensed band and determining the UE has access to a licensed band; tolerable delay for uplink or downlink communications with the WD 22; link quality for uplink or downlink communications with the WD 22; x-slot delay for uplink or downlink communications with the WD 22; network load; Channel Status Information, CSI, reporting period for the WD 22; periodicity relation of the monitoring patterns; user assistance information, UAI; type of traffic, the service type used by the UE; a UE type indication; length of the on-duration of a Discontinuous Reception cycle, DRX-cycle; inactivity timer; data inter-arrival time; average burst length; and SS-switch timer.

In some embodiments, the network node 16 determines a configuration of the underlying parameters for SS switching, as well as criteria to be used to determine to which group to switch, based on the frequency band operation of the WD 22. For example, if the WD 22 operates in unlicensed bands, the network node may configure the first SS as the sparse SS and the second one as the dense one, and then switch from the sparse SS to the dense SS if, based on Listen Before Talk (LBT), a channel access is deemed feasible. Alternatively, the WD 22 may be configured with two dense SS modes, a sparser second one and a denser third one, and so, when moving from the first sparse SS to one of the denser SSs, the network node may decide to indicate the WD 22 to move to the second SS, if the load is lower than a specific threshold to thus save UE power, but if load is higher than the threshold, then the network node may indicate the WD 22 to move to the third SS. Alternatively, if the WD 22 operates in licensed bands, the network node may prioritize UE power consumption reduction in determining the configuration parameters as well as the criteria to switch the WD 22.

Determination of the SS-Group Index

In some embodiments, the choice which SS patterns allocated to which certain groups determines which switching and triggering mechanisms are available to those groups. The mechanisms may include switching with an explicit command, switching via transmitting a scheduling DCI, and switching at timer expiry.

To determine the group index, i.e. whether an SS-group should be the S S-group0 or S S-group1, or SS-groupx if more than 2 groups are configured, the network node may consider several aspects such as the length of the on-duration of the DRX-cycle, the inactivity timer, the data inter-arrival time, average burst length, and SS-switch timer. The decision amounts to choosing which SS set (group0) is the default group to which the WD 22 returns after a predetermined length of inactivity and which SS set (group1) is invoked by data arrival or command. Directly or indirectly, the WD 22 type and traffic/service type may also be used for determining which SS group index, with associated available switching mechanisms, is assigned to which SS type and the number and types of the patterns in the setup.

In one example, if the on-duration of the DRX cycle is quite long (e.g. 10 ms) and (optionally) SS-switch timer and/or inactivity timer are relatively short, the network node may configure the sparser SS-group as SS-group0 and the denser SS-group as SS-group1.

In another example, if the on-duration is short (e.g. only 1 slot or 2 slots), the SS-switch timer is similar with the inactivity timer, and the mean data inter-arrival time is sufficiently larger than that of inactivity timer+average burst length, the network node may configure the denser SS-group as SS-group0 and the SS-group with no PDCCH MO as SS-group1. In some embodiments, the SS switching configuration may then be used to mitigate the impact of temporary traffic and cDRX configuration mismatch when the network node chooses not to reconfigure the cDRX to continuously match the traffic patterns.

For the case of three SS-groups configurations, the network node may configure the WD 22 with sparser SS-group as SS-group0, denser SS-group as SS-group1, and SS-group with no PDCCH MO as SS-group2.

For the case of the WD 22 is configured with carrier aggregation, the network node can configure the PCell with sparser SS-group as SS-group0 and denser SS-group as SS-group1; and configure the SCell with SS-group with no PDCCH MO as SS-group0 and denser SS-group as SS-group1. This configuration, in particular, can be implemented when the SS-switch in the PCell also triggers SS-switch in the SCell. Using this setting, the SCell will only wake-up (perform PDCCH monitoring) when there is data for the WD 22.

In some embodiments, the network node 16 may mix both BWP switching-based and SS set switching-based SS adaptation. In this way, up to 2×2 SS sets may be available of 2 BWPs are alternated and, in each BWP, 2 SS sets are alternated. For the case when the network node configures the WD 22 with more than one BWPs, the network node may have several alternatives. First, the network node may configure the default BWP with one SS-group having sparse PDCCH MOs and the other BWP with two SS-groups having an SS-group with dense PDCCH MOs and an SS-group with zero PDCCH MO. This may be suitable for the case when the WD 22 application has a relatively large acceptable delay, the BWP-switch timer is relatively long (e.g. due to the smaller sub-carrier spacing and lower WD 22 capability), and the WD 22 is more power sensitive. This is because this configuration may cause a notable delay when switching between sparser SS-group to denser SS-group, but it has faster transition from the denser-SS group to the SS-group with no PDCCH MO.

Alternatively, in some embodiments, if the WD 22 application has a relatively small acceptable delay and the WD 22 is not power-sensitive, the network node may configure the default BWP with two SS-groups in which one SS-group having sparse PDCCH MOs and one SS-group having dense PDCCH MOs; and the other BWP with one SS-group having zero PDCCH MO. In this configuration, the WD 22 can switch faster to the denser-SS (thus, incurs a smaller delay), but might need more time to go to the SS-group with no PDCCH MO.

For those two alternatives above, the network node may further set the BWP-inactive-timer to be the same as the inactivity timer.

Determination of the SS Periodicity

In some embodiments, the SS periodicity of a sparser SS-group is based on a tolerable delay of a WD application. The network node 16 may configure the sparse SS so that the period does not exceed the excess delay limit at the physical layer.

In some embodiments, on top of a WD application, the network node may also consider the link quality of the WD (either during connection or the history of the link quality of the respected WD. If the link quality is below a certain threshold, the network node may reduce the period of the PDCCH MO of this sparser SS-group.

In some embodiments, the PDCCH MO periodicity of the sparser SS-group may also be based on the minimumSchedulingOffsetK0 and minimumSchedulingOffsetK2 value configured for the WD, the minimum value of K0 (and K2) configured for the WD, or preferred minimumSchedulingOffsetK0 and minimumSchedulingOffsetK2 value sent by the WD through UE assistance information. In some embodiments, the period is not set shorter than the minimum offset value.

In some embodiments, the network node may also set the PDCCH MO period of the sparser SS-group as the integer multiple of the PDCCH MO period of the denser SS-group to reduce the impact of misalignment between the network node and the WD. For example, if the network node configures the period of the denser SS-group with a value of 2 slots, and the minimumSchedulingOffset with a value of 5 slots, the network node then can set the period of the sparser SS-group with a value of 6 slots, i.e. rounding 5 to the nearest integer multiple of 2.

For the denser SS-group, the SS period in one example can be set to 1, i.e. the PDCCH MO is conducted in every slot. In another example, the network node may configure the periodicity based on the current load in the network node. For example, the network node may configure the WD with SS period longer than one (e.g. 2) as based on the current network node load, the network node will not be able to schedule the WD in every slot. Note that in doing so, the network node should also consider PDCCH blocking probability. At high load, therefore, the network node may configure a short SS period to maximize the scheduling opportunity to a given WD.

In some embodiments, when configuring a very sparse SS to emulate a WUS or dormancy, the network node may configure the sparse SS based on a CSI report request or a SRS transmission request periodicity. For example, if the network node requests a CSI report from the WD every 40 ms or within a range from that, the SS periodicity can be aligned accordingly, so thar the network node has access to the up-to-date CSI status of the WD.

In some embodiments, the SS periodicity of each SS-group is additionally related to the employed numerology. For example, the sparse SS periodicity for 15 kHz may be set as 1, but for 120 kHz as 4 or 8 to approximately maintain the absolute time gaps between the MOs.

Determination of the Offset Value of the SS

As mentioned above, in some embodiments, the PDCCH MO of the SS configuration used when the DRB status is inactive is sparser than a PDCCH MO of an SS configuration used when the DRB status is active, and the network node 16 configures the WD 22 with an offset value such that the PDCCH MO used when DRB status is inactive is non-overlapping with the PDCCH MO used by another WD served by the same network node. In some embodiments, the offset value comprises an offset in frequency and/or time. In some embodiments, the WD 22 and the another WD have an inactive DRB status.

In some embodiments, the network node 16 can configure the offset value of the sparser SS-group based on the location of the periodic signaling sent by the network node, e.g. periodic or quasi-periodic request of aperiodic CSI-RS report, periodic or quasi-periodic signaling of aperiodic CSI-RS measurement, SSB, etc. For example, the network node may configure the PDCCH MO of the sparser SS-group to be as close as possible to the periodic signaling. The quasi-periodic signaling refers herein to the signaling that may not be occasionally periodic, however, within a small range from a specific periodicity.

In some embodiments, in addition to the above, the network node may also configure the WD with the offset value of the sparser SS-group so that the PDCCH MO does not overlap with PDCCH MO of, in particular, the sparser SS-group of the other WDs in time and/or frequency. The network node, therefore, may configure the sparser SS-group of the WDs to have the same PDCCH MO in the time domain when the network node is still able to set the PDCCH MO of the sparser SS-group of those WDs to be in the different frequency location.

In various embodiments, SS switching alternates between different PDCCH monitoring patterns depending on traffic arrival patterns. In some embodiments, an offset may be configured between at least two monitoring patterns based on at least one of: location of periodic signaling and PDCCH MO, to avoid overlap of the at least two monitoring patterns.

Determination of the Duration in One SS Period

In one SS period, the network node may configure more than one slot for PDCCH MO. For the sparser SS-group, in an example, the network node may simply configure the duration as 1 slot. In another example, for the sparser SS-group, the network node may consider the network node load, i.e. to minimize the PDCCH blocking probability and increase network node scheduling flexibility. For example, when the network node load is low, the duration of the sparser SS-group can be set to 1 slot, and can be set to more than 1 slots when the network node load is relatively high (e.g. above a certain threshold).

In another example, if the SS periodicity is aligned with the periodic or quasi-periodic request of an aperiodic operation, e.g., CSI-RS report or SRS transmission, the network node may increase the duration to cover the range of the time within which the request may be sent to the WD.

In some embodiments, the duration may consider the WD energy consumption impact of longer monitoring per SS period. Using, e.g. the WD power consumption model, the network node may assess the incremental energy due to longer monitoring and limit the extension so that the energy penalty compared to monitoring a single slot, or the shortest feasible MO duration, remains below a predetermined or WD-specific threshold.

Determination of the Value of a Switching Timer

In Rel-16, a UE (also referred to as a WD herein) can be provided by searchSpaceSwitchingTimer-r16, a timer value. The UE decrements the timer value by one after each slot in the active DL BWP of the serving cell where the UE monitors PDCCH for detection of DCI format 2-0.

In some embodiments, rather than having a single timer (Rel-16 searchSpaceSwitchingTimer) that switches SS groups, cell-specific or cell-group-specific timers may be introduced and configured. For example, cells belonging to frequency range 2 (FR2) can be configured with a shorter switching timer and, upon inactivity (e.g., if there is no DCI reception related to these cells), these cells can revert to a sparse SS earlier than cells configured for frequency range 1 (FR1).

In one example, the determination of the value of the switching timer can be based on the network load. For example, if the network node load is high (e.g., the number of the connected WDs in the network node is high), the switching timer can be set to a larger value to remain in dense monitoring and provide more scheduling opportunities; and conversely, when the network node load is low, the switching timer can be set to a shorter, or smaller, value.

In another example, the determination of the length of the switching timer can be based on the maximum length between the PDCCH slot and the respective ACK slot, i.e. the HARQ feedback offset, to ensure a re-transmission opportunity, if required.

In another example, the determination of the switching timer can also consider the TDD configuration that will be used by the WD. For example, the value of the timer can be the multiple of the maximum distance between two downlink slots of the TDD format configured for the WD. This can be beneficial because the last slot before the WD goes to the sparser SS-group will be the downlink slot.

In yet another example, the value of the switching timer configured for a WD might be based on the statistics on the application that the WD is currently running. For example, the timer can be set to have a value equal to or larger than the average or the maximum distance between two PDSCH slots in a single data burst recorded for the respective application.

Note that the above factors can be used to determine the switching timer value either independently or jointly. For example, for a WD with an application A running, with a maximum distance between two PDSCH slots of a data burst (obtained from the statistics) of X ms. The network node can configure the WD with switching timer of X ms when the network node load is low and increase the switching timer when the network node load is high. In another example, the network node may differ the historical statistical record for each application and each network node load scenario.

For the case of an SS-group with zero PDCCH MO is configured (e.g. to mimic the GTS signal) the SS-switch timer can be set to be the same as the inactivity timer. In a related realization, the switching timer may be set such that the WD switches to a denser SS, e.g., in case the network node would like to request a CSI-RS report.

Determination of the Size of the Frequency and/or Time Resources

In one example, the network node may also relate the frequency and/or time resource configuration to the periodicity of the PDCCH MO. For example, for the sparser SS-group, the network node may configure a narrower frequency and/or resources in the CORESET.

In 5G NR, CORESET is known as Control Resource Set. It is a set of physical resources within a specific area in Downlink Resource Grid and used to carry PDCCH (DCI). NR PDCCHs are specifically designed to transmit in a configurable control resource set (CORESET). A CORESET is analogous to the control region in LTE but is generalized in the sense that the set of RBs and the set of OFDM symbols in which it is located are configurable with the corresponding PDCCH search spaces. Such configuration flexibilities of control regions including time, frequency, numerologies, and operating points enable NR to address a wide range of use cases.

In LTE control region, the PDCCH is allocated across entire system bandwidth but NR PDCCH is transmitted in specifically designed CORESET region to a specific region in frequency domain as shown in below picture.

Frequency allocation in a CORESET configuration can be contiguous or non-contiguous. CORESET configuration in time spans 1-3 consecutive OFDM symbols. The REs in a CORESET are organized in RE groups (REGs). Each REG consists of the 12 REs of one OFDM symbol in one RB. A PDCCH is confined to one CORESET and transmitted with its own demodulation reference signal (DMRS) enabling UE-specific beamforming of the control channel. A PDCCH is carried by 1, 2, 4, 8 or 16 control channel elements (CCEs) to accommodate different DCI payload size or different coding rates. Each CCE consists of 6 REGs. The CCE-to-REG mapping for a CORESET can be interleaved (for frequency diversity) or non-interleaved (for localized beamforming).

The WD 22 may be configured to blindly monitor a number of PDCCH candidates of different DCI formats and different aggregation levels. The blind decoding processing has an associated UE complexity cost but is required to provide flexible scheduling and handling of different DCI formats with lower overhead.

Contrary, for the denser SS-group, the network node may configure a wider frequency and/or time resources in the CORESET. In determining this configuration, the network node may also consider the link quality. For example, the sparser-SS may have narrower frequency resources when the link quality is equal to or above a certain threshold. When the link quality is below a certain threshold, the frequency resources can be set to be the same for both sparser and denser SS-groups.

In some embodiments, the configuring for the UE of the parameters for the at least two monitoring patterns includes configuring size of frequency resources used for one of the monitoring patterns based on Physical Downlink Control Channel, PDCCH, monitoring opportunity, MO, periodicity of the one of the monitoring patterns and based on link quality for UE communications.

Determination of the Type of Switching Mechanism

The network node may employ an explicit mechanism, e.g., as in a DCI 2-0 with an explicit bitfield, or an implicit mechanism, e.g., the timer-based approach, or based on receiving a DCI which does not necessarily include an explicit bitfield for SS switching.

In one approach, the choice may be based on the anticipated rate of SS switching. If the network node does not intend to frequently perform SS switching, the explicit mechanism is employed, but if the switching is more frequent, or periodic/quasi-periodic, then the implicit mechanisms can be employed.

In some embodiments, the network node sends a communication to the UE indicating which monitoring pattern the UE should operate. The sending may include generating a DCI message, the DCI message including an explicit indication to the WD 22 to switch to an indicated one of the at least two monitoring patterns, and causing transmission of the DCI message on a downlink control channel to trigger the WD 22 to switch to the indicated one of the at least two monitoring patterns in response to the explicit indication in the DCI message.

In some embodiments, operations performed by the network node further include initiating the generation and transmission of the DCI message, including the explicit indication to the WD 22 to switch to the indicated one of the at least two monitoring patterns, based on the indicated one of the at least two monitoring patterns having a denser monitoring opportunity, MO, pattern for traffic arrival which increases scheduling flexibility.

In some embodiments, the initiation of the generation and transmission of the DCI message, is further based on the switching criteria being satisfied by at least one of: buffer status of the WD 22; UE uplink or downlink traffic statistics; UE capability characteristic; a change to UE uplink or downlink traffic statistics; and a change to UE service type.

In some embodiments, operations performed by the network node 16 further include initiating the generation and transmission of the DCI message (e.g., a scheduling DCI message), including the explicit indication to the WD 22 to switch to the indicated one of the at least two monitoring patterns, based on the indicated one of the at least two monitoring patterns having a sparser monitoring opportunity, MO, pattern for traffic arrival which decreases scheduling flexibility.

In some embodiments, the initiation of the generation and transmission of the DCI message (e.g., a scheduling DCI message), including the explicit indication to the WD 22 to switch to the indicated one of the at least two monitoring patterns, is further based on the switching criteria being satisfied by at least one of: buffer status of the WD 22; feedback status from the WD 22; link quality; average number of Physical Downlink Shared Channel, PDSCH, retransmissions; inactivity timer length; data inter-arrival time; network load; the UE operating in an unlicensed band and determining the UE has access to a licensed band; a change to UE service type; a change to UE uplink or downlink traffic statistics; and a request from the WD 22.

In some embodiments, the sending a communication to the UE indicating which monitoring pattern the UE should operate based on the switching criteria, includes generating a DCI message (e.g., a scheduling DCI message), the DCI message including an explicit indication to the WD 22 to remain in a current one of the at least two monitoring patterns, and causing transmission of the DCI message on a downlink control channel to trigger the WD 22 to remain in the current one of the at least two monitoring patterns in response to the explicit indication in the DCI message.

In some embodiments, the configuring for the WD 22 parameters for at least two monitoring patterns and a switching criteria controlling the WD 22 switching between the at least two monitoring patterns including configuring the WD 22 for implicit switching between the at least two monitoring patterns in response to receiving a downlink control information DCI format (e.g., a scheduling DCI format). the sending a communication to the WD 22 indicating which monitoring pattern the UE should operate includes causing transmission of the DCI format to trigger the WD 22 to switch between monitoring patterns.

In some embodiments, the configuring for the WD 22 of the switching criteria controlling the UE switching between the at least two monitoring patterns includes configuring the WD 22 to switch between the at least two monitoring patterns in response to a timer expiry after receiving a downlink control information, DCI, format (e.g., a scheduling DCI format) during the timer duration. In some embodiments, the configuring of the duration of the timer is based on at least one of: network load; hybrid automatic repeat request, HARQ, offset; time division duplex, TDD, configuration; UE uplink or downlink traffic statistics; UE application data characteristic; and Connected Mode Discontinuous Reception, cDRX, inactivity timer.

Search Space Switching Criteria Aspect

Having more than one SS-groups, the network node may decide to move the WD 22 from one group to the other group. Such indication can be signaled to WD 22 through DCI format 2-0 as in the current Rel. 16 standard on explicit SS-group switching mechanism, through an explicit DCI command in the scheduling DCI format mentioned above, through implicit indication from the scheduling DCI (used in the current Rel. 16 standard), through the expiration of SS-group switching timer, etc. The switching indication can also be signaled through the BWP-switch mechanism. For the case of the network node uses scheduling DCI to switch the SS-group of a WD 22 and there is no data has to be scheduled for that WD 22, the network node can send a dummy PDCCH (PDCCH without actual PDSCH transmission) which still includes the SS-switch indication. To determine whether the WD 22 should move to the other SS-group or to remain in the current SS-group, some criteria that can be used by the network node are presented. In addition, methods that can be used by the network node for scheduler prioritization given the SS configuration are also given.

In some embodiments, the configuring for the WD 22 of the switching criteria controlling the WD 22 switching between the at least two monitoring patterns, includes configuring relative priorities of the at least two monitoring patterns based on a number of Physical Downlink Control Channel, PDCCH, monitoring opportunities, MOs, and location of a next MO.

Switching to the Denser SS-Group

In some embodiments, the network node 16 may command or instruct the WD 22 to switch to the denser SS-group when data burst for the respected WD 22 arrives.

In some embodiments, the network node 16 may command the WD 22 to switch to the denser SS-group as the network node requires a more relaxed scheduling flexibility (although there is still no data in the buffer for those UEs). This, for example, can happen when too many UEs are in the sparse SS-group and the PDCCH MO of those sparse SS-group may have the same T/F location and thus, the PDCCH blocking probability is considered high.

In the above case, the network node 16 may simply command all UEs in the sparser SS-group to switch to their denser SS-group. In another example, the network node may also choose certain UEs to change to denser SS-group based on one or more available information, e.g. the UE-suggested or network node-configured minK0 (and minK2) value. In this case, the UE with lower minK0 value may have a higher priority to be switched to denser SS-group. The network node may also use the historical traffic data, i.e. the WD 22 that has a higher probability to soon have data in the buffer will have a higher priority to be switched to the denser SS-group. In addition, the network node may also use WD 22 capability to decide which WD 22 can be switched to the denser SS-group, i.e. the WD 22 with higher capability will have a higher probability to be switched to the denser SS-group.

In another example, the network node 16 may decide to switch the WD 22 to the denser SS-group based on the DL buffer status or BSR. In case the data buffer is above a threshold, the network node switches the WD 22 to the dense SS-group, or in case more than two SS-groups are configured, if the buffer status is with a specific range, the network node can indicate the WD 22 to switch to a specific SS-group.

In another example, the network node 16 may decide to switch the WD 22 to a denser SS-group if the current application or service changes to one which demands higher data traffic, or lower latency. E.g., if the service type changes to URLLC, the WD 22 may be indicated to switch to the densest SS-group, or if the current service is IoT and it changes to eMBB, the WD 22 may be indicated by the network node to switch to a denser SS.

Switching to the Sparser SS-Group

In some embodiments, the network node 16 may decide that the WD 22 should switch to the sparser SS-group when it knows that the buffer for the respective WD 22 is empty. Alternatively, the buffer might have some remaining data, but it can be emptied using the next one PDSCH, or it is below a threshold, or a range which is considered as low traffic.

In some embodiments, the network node 16 may decide that the WD 22 should switch to the sparser SS-group when the expected feedback from the WD 22 is received. For the case of PDSCH is transmitted, the feedback might be in term of ACK while for aperiodic CSI-RS, the expected feedback is the CSI report.

The implementation of the above two criteria may also be adopted by the network node dynamically, e.g. based on the link quality or the average number of PDSCH retransmission of the respective WD 22. For example, when the link quality is the same or above a certain threshold, the network node may command the WD 22 to switch to the sparser SS-group when the buffer is empty, i.e. without waiting for ACK. Conversely, when the link quality is below a certain threshold, the network node may command the WD 22 to switch to the sparser SS-group when the ACK of the last PDSCH transmission is received.

For the case when an SS-group with zero PDCCH MO is configured, the above two criteria might also be used for the network node to command the WD 22 to switch to the SS-group with zero PDCCH MO. On top of that, the network node may also consider the inactivity timer length and the mean data inter-arrival time. For example, the network node will command the WD 22 to switch to the SS-group with zero PDCCH MO only if the network node expects that the next data burst will come after the inactivity timer ends.

In some embodiments, the network node 16 may command the WD 22 to switch to the sparser SS-group because the network node load increases and the network node anyway will not be able to schedule the WD 22 with the periodicity of the denser SS-group. Note that this should also consider the acceptable delay of the application running in the WD 22. In addition, the T/F location of the sparser SS-group of the respected WD 22 should not collide with the T/F location of the sparser SS-group of other UEs.

In some embodiments, the WD 22 may be switched to a sparser SS, in case the type of application or service changes. For example, if the service type changes from eMBB to IoT, or from URLLC to eMBB, the WD 22 may be switched to a sparser SS. Or in case, the UE traffic application changes to a less frequent one such as IM instead of interactive gaming, the WD 22 may be switched to a sparser SS.

Remaining in the Sparser SS

In some embodiments, instead of switching, the network node 16 may also determine that the WD 22 should remain in the same SS-group, e.g. remain in the sparser SS-group. Particularly, if the timer-based approach is used, the WD 22 may switch to a different SS, if no alternative indication is received.

In one example, the network node 16 may simply determine that the WD 22 should remain in the sparser SS-group when there is no data for the respective WD yet.

In another example, the network node 16 may determine that the WD should remain in the sparser SS-group when the network node expects that it will only send one PDCCH inside one sparser SS-group's periodicity. For example, when the data in the buffer is enough to be included in only one PDSCH or the network node only send an aperiodic CSI-RS or aperiodic sounding reference signal (SRS). The network node may expect this, (i.e. the network node will send only one PDSCH during the sparser SS-group's periodicity), based on the buffer status and the current network node load.

In another example, the network node 16 defines a range of buffer status (both DL and UL, or either of them), and, if the UE buffer status remains in the same range, the network node decides to keep the WD 22 in the same SS-group.

In another example, if the current service or traffic application remains the same, the network node may decide to keep the WD 22 in the same SS-group.

Remaining in the Denser SS

In some embodiments, the network node 16 may determine that the WD 22 should remain in the denser SS-group when there is still data in the buffer.

The network node 16, however, may decide that the WD 22 should remain in the denser SS-group, e.g. even when the buffer for the respected WD 22 is empty. In one example, the network node may decide to do so as the network node expects some data will come (e.g. based on the statistical traffic history) before the next PDCCH MO of the sparser SS-group.

In some embodiments, the network node 16 may decide to remain in the denser SS even when the probability of the data to come is considered as low (but larger than 0). This decision can be taken when the switching timer is considered as short (below a certain threshold). I.e. if the data indeed does not come, the WD 22 will anyway go to the sparser SS-group soon.

Note that the network node 16 may also want to keep the WD 22 in the denser SS-group for a time exceeding the configured SS-switch timer. In this case, the network node may send a dummy PDCCH (if the scheduling DCI or implicit indication is used for SS-switch) or send a PDCCH via other available DCI formats for SS-switch (e.g. DCI 2-0), i.e. to restart the SS-switch timer.

In another example, the network node 16 defines a range of buffer status (both DL and UL or either of them), and if the WD 22 buffer status remains in the same range, the network node decides to keep the WD 22 in the same SS-group.

In another example, if the current service or traffic application remains the same, the network node may decide to keep the WD 22 in the same SS-group.

User Assistance Information Consideration

In some embodiments, the network node 16 determines that the WD 22 should switch to or remain in a certain SS-group based on the network node evaluation (i.e. the network node evaluates several parameters such as buffer status, type of traffic, etc.). In some embodiments, the network node may determine this based on the WD request (assistance information). For example, the WD 22 may consider its own type of traffic, application, power consumption status, etc., and send a request to change to or to remain in the other SS-group.

Scheduler Prioritization

In some embodiments, when the network node 16 configures one or more WDs with more than one SS-group, the network node may apply scheduler prioritization based on the currently applied SS-group periodicity of the UEs. In some embodiments, WDs with SS including fewer MOs may be prioritized over WDs with abundant MOs, subject to not violating latency constraints. For example, a WD in a sparser SS-group may have a higher scheduling priority compared to that of a WD which is in the denser SS-group, i.e., if they occupy the same frequency resources.

In some embodiments, the network node 16 may configure the scheduler prioritization based on the location of the next monitoring occasion. For example, the WD 22 having the farthest next PDCCH monitoring occasion may have the highest scheduler prioritization.

### Some Examples

Example 1. A method in a network node 16 to adapt wireless device 22 operation for improved power saving mode during DRB inactive time, comprising
obtaining a current DRB status [DRB active/DRB inactive, DRB elapsed duration],
determining a DRB activity metric based at least on the current DRB status [DRB inactivity ratio, DRB inactivity duration],
selecting a PS adaptation measure based at least on the DRB activity metric,
causing the wireless device 22 to operate in the selected operating regime [explicit signaling, timer, RRC reconfiguration].

Example 2. The method of Example 1, further including applying filtering to current and past DRB status parameters to determine the DRB activity metric.

Example 3. The method of Example 1, the DRB activity metric being DRB inactivity ratio or DRB inactive duration.

Example 4. The method of Example 1, the power saving adaptation measure may be any of the following:
control signaling transmission strategy to avoid triggering TAT;
reconfiguring C-DRX parameters;
PDCCH MO/SS reconfiguration;
WUS configuration;
Scell dormancy or activity status indication;
MIMO layers reconfiguration;
cross-slot scheduling reconfiguration;
BW reconfiguration; and
CSI reporting rate.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

### Embodiments

Embodiment A1. A network node configured to communicate with a wireless device (WD), the network node configured to, and/or comprising a radio interface and/or comprising processing circuitry configured to:
determine a data radio bearer, DRB, status; and
indicate a power saving configuration to the wireless device for implementation based at least on the DRB status.

Embodiment A2. The network node of Embodiment A1, wherein the processing circuitry is further configured to:
determine a DRB metric based at least on the DRB status; and
determine whether the DRB metric meets a predefined criterion, the indication of the power saving configuration being based at least on the DRB metric meeting the predefined criterion.

Embodiment A3. The network node of Embodiment A2, wherein the DRB metric is one of a DRB inactivity ratio and DRB status inactive duration.

Embodiment A4. The network node of Embodiment A1, wherein the power saving configuration includes one of:
a control signaling transmission configuration to avoid triggering IAT;
a reconfiguring connected mode-Discontinuous Reception (C-DRX) parameter;
a physical downlink control channel (PDCCH) monitoring occasion/search space (MO/SS) reconfiguration;
a wake-up signal (WUS) configuration;
a secondary cell (Scell) dormancy or activity status indication;
a multiple-input multiple-output (MIMO) layers reconfiguration;
a cross-slot scheduling reconfiguration;
a bandwidth (BW) reconfiguration; and
a channel state information (CSI) reporting rate reconfiguration.

Embodiment B1. A method for a network node that is configured to communicate with a wireless device, the method comprising:
determining a data radio bearer, DRB, status; and
indicating a power saving configuration to the wireless device for implementation based at least on the DRB status

Embodiment B2. The method of Embodiment B1, further comprising:
determining a DRB metric based at least on the DRB status; and
determining whether the DRB metric meets a predefined criterion, the indication of the power saving configuration being based at least on the DRB metric meeting the predefined criterion

Embodiment B3. The method of Embodiment B2, wherein the DRB metric is one of a DRB inactivity ratio and DRB status inactive duration.

Embodiment B4. The method of Embodiment B1, wherein the power saving configuration includes one of:
a control signaling transmission configuration to avoid triggering IAT;
a reconfiguring connected mode-Discontinuous Reception (C-DRX) parameters;
a physical downlink control channel (PDCCH) monitoring occasion/search space (MO/SS) reconfiguration;
a wake-up signal (WUS) configuration;
a secondary cell (Scell) dormancy or activity status indication;
a multiple-input multiple-output (MIMO) layers reconfiguration;
a cross-slot scheduling reconfiguration;
a bandwidth (BW) reconfiguration; and
a channel state information (CSI) reporting rate reconfiguration.

Embodiment C1. A wireless device (WD) configured to communicate with a network node, the WD configured to, and/or comprising a radio interface and/or processing circuitry configured to:
receive an indication of a power saving configuration for implementation, the power saving configuration being based at least on a data radio bearer, DRB, status; and
optionally implement the power saving configuration.

Embodiment C2. The WD of Embodiment C1, wherein the power saving configuration includes one of:
a control signaling transmission configuration to avoid triggering IAT;
a reconfiguring connected mode-Discontinuous Reception (C-DRX) parameters;
a physical downlink control channel (PDCCH) monitoring occasion/search space (MO/SS) reconfiguration;
a wake-up signal (WUS) configuration;
a secondary cell (Scell) dormancy or activity status indication;
a multiple-input multiple-output (MIMO) layers reconfiguration;
a cross-slot scheduling reconfiguration;
a bandwidth (BW) reconfiguration; and
a channel state information (CSI) reporting rate reconfiguration.

Embodiment C3. The WD of Embodiment C1, wherein the indication is received in higher layer signaling.

Embodiment D1. A method implemented in a wireless device (WD), the method comprising:
receiving an indication of a power saving configuration for implementation, the power saving configuration being based at least on a data radio bearer, DRB, status; and
optionally implementing the power saving configuration

Embodiment D2. The method of Embodiment D1, wherein the power saving configuration includes one of:
a control signaling transmission configuration to avoid triggering IAT;
a reconfiguring connected mode-Discontinuous Reception (C-DRX) parameters;
a physical downlink control channel (PDCCH) monitoring occasion/search space (MO/SS) reconfiguration;
a wake-up signal (WUS) configuration;
a secondary cell (Scell) dormancy or activity status indication;
a multiple-input multiple-output (MIMO) layers reconfiguration;
a cross-slot scheduling reconfiguration;
a bandwidth (BW) reconfiguration; and
a channel state information (CSI) reporting rate reconfiguration.

Embodiment D3. The method of Embodiment D1, wherein the indication is received in higher layer signaling.

1.-32. (canceled)

33. A method performed by a network node that is configured to communicate with a wireless device, WD, the method comprising:
determining a data radio bearer, DRB, status of the WD;
determining one or more bandwidth parts, BWPs, and/or one or more search space, SS, configurations of one or more BWPs for the WD based on the DRB status;
when the DRB status is inactive, enabling a power saving mode for the WD by configuring the WD with one or more BWP from the determined one or more BWPs and/or one or more SS configurations from the determined one or more SS configurations of the one or more BWPs for the WD based at least on the DRB status; and
when the DRB status is active, disabling the power saving mode or not enabling the power saving mode.

34. The method according to claim 33, wherein the configuring the WD with the SS configuration comprises:
determining a physical downlink control channel (PDCCH) monitoring occasion (MO) configuration associated the SS configuration; and/or
determining at least one BWP having the SS configuration.

35. The method according to claim 33, comprising disabling the power saving mode or not enabling the power saving mode by configuring the WD with a different SS configuration of the one or more BWPs for the WD.

36. The method according to claim 33, wherein the one or more BWPs and/or the one or more SS configurations relate to a WD type, a WD traffic type, and/or a service requirement.

37. The method according to claim 33, wherein determining the one or more SS configurations is performed using one or more criteria that comprise one or more out of:
a DL buffer occupancy of the WD in the network node;
a total DL buffer occupancy in the network node of WDs which the network node is serving;
a UL buffer occupancy of the WD;
a buffer occupancy in the network node of another WD in a communication system comprising the network node and the WD;
an energy consumption of the WD;
DL and/or UL radio resource consumption; a
scheduling delays;
at least one time division duplex, TDD, configuration and/or at least one TDD pattern used in a DL and/or a UL in the one or more BWPs.

38. The method according to claim 33, wherein
the DRB status is determined at least in part based on a buffer occupancy of the WD,
the DRB status is inactive when the buffer occupancy of the WD is zero or less than a threshold, and
the DRB status is active when the buffer occupancy of the WD is not zero or greater than the threshold.

39. The method according to claim 33, wherein
the DRB status is determined at least in part based on a DRB inactivity ratio of the WD,
the DRB status is inactive when the DRB inactivity ratio of the WD is above a third threshold, and
the DRB status is active when the DRB inactivity ratio of the WD is below the third threshold.

40. The method according to claim 39, wherein any one or more out of the threshold, the second threshold, and the third threshold are determined based on a WD type, a WD traffic type, and/or a service requirement.

41. The method according to claim 33, wherein
the PDCCH MO of the SS configuration used when the DRB status is inactive is sparser than a PDCCH MO of an SS configuration used when the DRB status is active, and
the network node configures the WD with an offset value such that the PDCCH MO used when DRB status is inactive is non-overlapping with the PDCCH MO used by another WD served by the same network node.

42. The method according to claim 33, wherein disabling or not enabling the power saving mode further comprises configuring a timer for the WD when the WD is configured with an SS configuration used for an active DRB status, and wherein, when the timer expires, the WD automatically switches to an SS configuration for an inactive DRB status.

43. A network node configured to communicate with a wireless device, WD, the network node being further configured to:
determine a data radio bearer, DRB, status of the WD;
determine one or more bandwidth parts, BWPs, and/or one or more search space, SS, configurations of one or more BWPs for the WD based on the DRB status;
when the DRB status is inactive, enable a power saving mode for the WD by configuring the WD with one or more BWP from the determined one or more BWPs and/or one or more SS configurations from the determined one or more SS configurations of the one or more BWPs for the WD based at least on the DRB status; and
when the DRB status is active, disable the power saving mode or not enabling the power saving mode.

44. The network node according to claim 43, wherein the network node configures the WD with the SS configuration by:
determining a physical downlink control channel (PDCCH) monitoring occasion (MO) configuration associated the SS configuration; and/or
determining at least one BWP having the SS configuration.

45. The network node according to claim 43, further being configured to disable the power saving mode or not enabling the power saving mode by configuring the WD with a different SS configuration of the one or more BWPs for the WD.

46. The network node according to claim 43, wherein the one or more BWPs and/or the one or more SS configurations relate to a WD type, a WD traffic type, and/or a service requirement.

47. The network node according to claim 43, wherein the network node determines the one or more SS configurations using one or more criteria that comprise one or more out of:
a DL buffer occupancy of the WD in the network node;
a total DL buffer occupancy in the network node of WDs which the network node is serving;
a UL buffer occupancy of the WD;
a buffer occupancy in the network node of another WD in a communication system comprising the network node and the WD;
an energy consumption of the WD;
DL and/or UL radio resource consumption; a
scheduling delays;
at least one time division duplex, TDD, configuration and/or at least one TDD pattern used in a DL and/or a UL in the one or more BWPs.

48. The network node according to claim 43, wherein
the network node determines the DRB status at least in part based on a buffer occupancy of the WD,
the DRB status is inactive when the buffer occupancy of the WD is zero or less than a threshold, and
the DRB status is active when the buffer occupancy of the WD is not zero or greater than the threshold.

49. The network node according to claim 43, wherein
the network node determines the DRB status at least in part based on a DRB inactivity ratio of the WD,
the DRB status is inactive when the DRB inactivity ratio of the WD is above a third threshold, and
the DRB status is active when the DRB inactivity ratio of the WD is below the third threshold.

50. The network node according to claim 49, wherein any one or more out of the threshold, the second threshold, and the third threshold are determined based on a WD type, a WD traffic type, and/or a service requirement.

51. The network node according to claim 49, wherein
the PDCCH MO of the SS configuration used when the DRB status is inactive is sparser than a PDCCH MO of an SS configuration used when the DRB status is active, and
the network node configures the WD with an offset value such that the PDCCH MO used when DRB status is inactive is non-overlapping with the PDCCH MO used by another WD served by the same network node.

52. The network node according to claim 43, wherein disabling or not enabling the power saving mode further comprises configuring a timer for the WD when the WD is configured with an SS configuration used for an active DRB status, and wherein, when the timer expires, the WD automatically switches to an SS configuration for an inactive DRB status.
